(19) United States
(12) Patent Application Publication
(10) Pub. No.: US 2010/0161821 A1
(43) Pub. Date: Jun. 24, 2010

(54) Midleware broker

(76) Inventor: Richard D. Slamkovic, Hampton (AU)

Correspondence Address: The Halvorson Law Firm, Ste 130, 1757 E. Baseline Rd., Gilbert, AZ, 85233, US

(21) Appl. No.: 12/316,975

(22) Filed: Dec. 18, 2008

(51) Int. Cl. G06F 15/16

(52) U.S. Cl. 709/230

(57) ABSTRACT

A method of flow of an outbound communication to another module with interface using a broker which is able to review all data structures, regardless of complexity, as being comprised of a finite set of primitive data types (e.g. integer, float etc.) and with reference to the repository determine a mechanism for reading and writing these types to enable processing of structures of arbitrary complexity, wherein the rules and mechanisms for reading these basic types are defined by the protocol and once the rules are captured allow processing of any message over this protocol

This application claims priority based upon International Application PCT/AU2007/000859 filed on 21 Jun. 2007 which is a continuation of Australian Provisional patent application no. 2006903351 filed on 21 Jun. 2006

### FIELD OF THE INVENTION

This invention relates to a middleware broker for middleware. In particular it relates to a data transfer means between various protocol systems to provide an integrated system.

### BACKGROUND OF THE INVENTION

Middleware is a software layer that aims to provide the glue between interacting components in a distributed computing environment. There is a variety of middleware types: among others, synchronous procedural RPC (Remote Procedure Call) oriented middleware, such as DCE-RPC, and asynchronous MOM (Message-Oriented-Middleware) based products, such as IBM's MQ-Series; transaction-oriented middleware include BEA's TUXEDO and IBM's CICS; more recently, object-based middleware, the best known of these being OMG's CORBA, Microsoft's DCOM and Java/RMI. Systems based on one of these methods are not directly protocol-level compatible with systems based on another. For example, a CORBA client is not plug-compatible with a DCOM server, even if both run on an NT platform. Although both systems are based on an object model, the implementations of these object-based systems are quite different.

The current corporate climate has placed pressure on many organisations to expand or to become part of larger existing networks. Companies are taking-over or merging with others, and small companies increasingly have had to join global networks to compete locally (e.g. “small companies, global networks”). The resulting super-organizations typically include a mix of generally incompatible IT systems, which need to be integrated to fully exploit the new structures. The problem of protocol-level systems integration is compounded if both companies use different operating environments. For example, a large company may use an IBM mainframe, while a smaller one uses Windows-based PCs. Ideally, the middleware should provide a pipeline to transparently support this communication. However, integration with legacy systems still requires significant amounts of coding.

The different approaches to inter-operability can be classified as:

Handcrafted Solutions: It consists of writing ad-hoc software to implement each interoperation requirement. Although this approach is widely applicable, and very commonly used, it is labour-intensive and requires considerable expertise not always available. Such approaches are also difficult to maintain over time.

Proprietary approaches (commercial EAI products): Usually result in the user being locked-in with a proprietary solution.

Architectural approaches: Provide mainly a high level modelling view of systems, and are not of much practical benefit to the low level systems integrator. Certainly, they do not allow for any automated protocol-level integration.

Specific middleware approach: Systems such as ASTER [14] provide an API that allows different protocols to be translated to CORBA. (i.e. ASTER relies on a single middleware, CORBA, to provide all remote (RPC) and component services.)

Protocol-level integration of legacy systems with other systems has been reported to be a major challenge with no obvious general solutions. Low-level systems integration is difficult, because application semantics must be addressed and low-level manual data marshalling is often required.

Direct translation between two different formats or, more generally, two different protocols is the oldest method of achieving data interchange. By writing custom computer source code that is later compiled and installed on the target platform, it is possible to achieve interoperability between two different data formats. If the source code is carefully tuned by someone very skilled in the art, the resulting translator will be a high-performance one. However, it will not work if any change in data format or protocol occurs, and will require additional programming and installation effort to adapt to any such change. Direct translation can offer excellent performance, but it is even less flexible than the static adapters used by “middleware” systems.

Instead of a static adapter or custom-coded direct translator, it is the use of some kind of data or protocol description that can offer greater flexibility and, thereby, connectivity. U.S. Pat. No. 5,826,017 to Holzmann (the Holzmann implementation) generically describes a known apparatus and method for communicating data between elements of a distributed system using a general protocol. The apparatus and method employs protocol descriptions written in a device-independent protocol description language. A protocol interpretation means or protocol description language interpreter executes a protocol to interpret the protocol description. Each entity in a network must include a protocol apparatus that enables communication via a general protocol for any protocol for which there is a protocol description. The general protocol includes a first general protocol message which includes a protocol description for a specific protocol. The protocol apparatus at a respective entity or node in a network which receives the first protocol message employs a protocol description language interpreter to interpret the included protocol description and thereby execute the specific protocol.

One known but not commonly known automated approach is that proposed by Dashofy et al. who investigated using various off-the-shelf middleware products to build bridges or connectors for distributed systems. They present their views from a software architecture perspective, restricted to the C2 architectural model. They have built software connectors that are specific to four middleware packages, Q, Polylith, RMI, and ILU. This means that to add support for another middleware package, a new specific connector (program) would need to be developed. Commercial tools such as those provided by commercial Enterprise Application Integration (EAI) products are similarly restricted.

A recently published granted US patent document is U.S. Pat. No. 6,772,413 which discloses a high level transformation method and apparatus for converting data formats in the context of network applications, among other places. A flexible transformation mechanism is provided that facilitates generation of translation machine code on the fly. A translator is dynamically generated by a translator compiler engine. The translator compiler engine implemented according to the present invention uses a pair of formal machine-readable format descriptions (FMRFDs) and a corresponding data map (DMAP) to generate executable machine code native to the translator platform CPU. When fed an input stream, the translator generates an output stream by executing the native object code generated on the fly by the translator compiler engine. In addition, the translator may be configured to perform a bi-directional translation between the two streams as well as translation between two distinct protocol sequences.

However this document discloses a translation method by generating a set of executable machine instructions for direct processing, said executable machine instructions being generated as a function of a data segment mapping, input format description and output format description, said executable machine instructions to translate an input data stream directly into an output data stream. Further the disclosure is primarily aimed at XML formats. This system is highly data bit intensive and therefore is primarily only suitable for repetitive processing of a single known protocol to another single known protocol.

### SUMMARY OF THE INVENTION

It is an object of the invention to provide an easier and flexible approach to provide a middleware broker for middleware protocols, as well as for legacy systems.

It is also an object of the invention to provide protocol-level inter-operability which supports a wide range of protocols, including legacy systems and could allow new protocol support to be added with no impact on existing systems (i.e. protocols can be changed (added or removed) without re-compilation of application software).

In accordance with the invention there is provided a system of intercommunication including the steps of:
defining the structure of one or more protocols used in communication and storing said structure in a library;
at run time analysing an input communication and determining an appropriate input structure of protocol of the input communication from the library and analysing the path of the intended output communication and determining an appropriate output structure of protocol of the output communication from the library;
providing a dynamic marshaller for processing at run time and sending the information in accordance with the identified output structure from the corresponding relevant sections of the identified input structure;

wherein the system allows ready communication between various protocols.

The system can include the library having a predefined conversion of the structure of one or more protocols to the structure of another of the one or more protocols.

The dynamic marshaller can provide buffering or addressing as required.

The system also provides for the dynamic marshaller to include definable predefined processing steps of corresponding relative sections of the identified output structure to the identified input structure.

It can therefore be seen that the predefined processing steps can be protocol neutral such that an end user can define the processing steps in a generic manner and the dynamic marshaller undertakes the required manipulation of the data in any communication based on the predefined processing step of the relevant section of the communication protocol structure. This provides a required effect regardless of the protocols of communication. The end user therefore need not be aware of the details of the protocol languages to enable a required manipulation. In particular there can be user defined or third party defined modules can be invoked at particular points during marshalling and un-marshalling (message processing).

In accordance with the invention there is provided a method of intercommunication of middleware including the steps of:
providing a table of initial definition of structure characteristics, including format and parameter data types, of one or more protocols;
converting said one or more structure protocol definitions into a selected format;
storing said one or more structure protocol definitions in said selected format in one or more repositories;
at run time assessing the incoming message and selecting an appropriate structure protocol definition to be used from the table and using the selected format of the converted structure protocol definition to communicate.

It can be seen that the method does not undertake a full conversion but instead, before the time of the message, a structure of the protocol has been defined and the data and information in the form of the protocol structure can be readily communicated in a protocol structure format that would be understood by the receiver.

The invention also provides a method of flow of an outbound communication to another module with interface including the steps of:
assessing the application of the outbound communication to determine and select a protocol to try from a table of protocols in a priority arrangement;
using the selected protocol to determine the format and arguments for the outbound communication;
using the protocol definitions stored to prepare the outbound communication for the particular middleware or application service;
providing required buffer;
determining which protocol to use for transmission;
looking up table of end-point resolutions to determine the communication parameters required to communicate with the selected transmission protocol;
attempting to communicate with the designated host using the appropriate communication parameters; and
if communication with the selected protocol fails selecting the next protocol to try from the table of protocols in the priority arrangement.

The invention also provides a method of flow of an inbound communication from another module with interface including the steps of:
receiving inbound message in the protocol that it was sent;
looking up table to determine whether the message needs marshalling into another protocol before passing the inbound communication to the target application on the local system;
if message needs marshalling into another protocol, determining the preferred protocol from a table according to priority;
determining the format and arguments for the inbound communication;
using stored protocol definitions for the selected protocol to prepare the inbound communication for the target middleware or application service;
buffering the inbound communication as required;
determining protocol to use for transmission.
determining local end point of the target application on the local system; and
at run time passing the inbound communication to the target application on the local system.

It can be seen that the invention provides an easier and flexible approach in which rules and middleware characteristics are specified in a repository, for the system broker to provide the connection and transformation for the middleware protocols, as well as for legacy systems. In particular it is not necessary to have a converter at either end of the communication. Further it is not necessary for there to be two way communication in order to ensure the receiver knows what format is arriving, instead the conversion due to the relevant structure format correlations allows ready flow of data from one input protocol to form readable by output protocol.

It should be noted that protocols are specified in a language neutral machine independent definition language. The language specifies the structure of messages and the parameter templates to establish a connection and exchange messages.

In one form of the invention the language neutral machine independent definition is compiled into binary modules known as protocol implementation modules (PIMs) and transport interface modules (TIMs). The TIMs contain the communication parameters.

These PIMs and TIMs are loaded at runtime and executed by interpreters (virtual machines). PIMs are processed by the dynamic adaptive marshaller (DAM) and the TIMs are handled by the transport mediation server (TMS). Both of these modules are controlled by the message distribution server (MDS). The MDS is also responsible for any interface mapping that is required. It uses either the processed request or response message and a mapping definition. The actual mapping is performed by a mapper module under the direction and control of the MDS.

In one preferred form of the invention the middleware broker is The Ubiquitous Broker Environment (the TUBE system). TUBE allows any defined interface to be marshaled across any defined protocol. This is achieved using existing clients and servers. There are no code changes. The protocol may be switched from A to . . . at runtime without requiring a stop/start of the application or TUBE runtime. The mode of the interaction may also be switched from say synchronous to asynchronous without operational impact. The client is oblivious to the change. In other words TUBE can make a synchronous protocol asynchronous and visa-versa. TUBE implements protocols using loadable modules called Protocol Implementation Modules (PIMs).

The major premise behind TUBE is that all data structures, regardless of complexity, are comprised of a finite set of primitive data types (e.g. integer, float etc.). Once we have a mechanism for reading and writing these types, we are able to process structures of arbitrary complexity. The rules and mechanisms for reading these basic types are defined by the protocol. Therefore, once we capture these rules we can process any message over this protocol.

For example CORBA uses an encoding known as CDR (Common Data Representation) for reading and writing basic data types. Once we have the rules of CDR or a callable library that implements the rules of CDR, we are able to process CDR-based (CORBA) messages. All we now have to do is define the structure of a CORBA request and response message.

This allows users or third-parties to create new protocols and drop them directly into their environment. The protocol does not even have to be physically implemented in a client or a server. A TUBE PIM on one side can act as the client and another PIM can act as a server on the target side. This enables use of the protocol without any coding. For example, an existing client using protocol XX is able to make a call to a server using XX. Without disruption to either client or server TUBE can intercept the XX message, convert it to the new protocol and send it across to the receiving node. At the receiving end, TUBE can convert back to protocol XX and pass to the original server. This allows users “to play” with protocols before actually implementing (or rewriting) existing clients or servers.

What if we want to add a new middleware? Let's say a bank wants to develop its own internal, secure middleware. They don't want to change all their client-side source code. Let us assume that the server-side has already been modified to support the new middleware. For the remainder of this discussion we shall refer to this new middleware as OSM (Our Secure Middleware) and to the existing middleware as XX. OSM requires that its payload be encrypted using its own crypto algorithm. The clients are still making calls via XX and are unaware of this requirement. OSM also introduces a new transport layer that is also encrypted. Without re-writing all the client code to use the new OSM APIs, How can the bank achieve integration?

TUBE provides a middleware definition tool specifically for this purpose. The tool consists of a number of modules, each dedicated to a specific task related to the definition. The first thing that needs to be defined is the payload format. This is defined as a binary sequence. It is also defined that this binary sequence must be obtained by a call-out to an OSM API, which carries-out the encryption.

The API module-name, signature and parameters are obtained in either of two ways; they can be imported from a C-language header or Java class definition, or be specified in the tool. This information is stored temporarily in a meta-language format called PDL (Protocol Definition Language).

The next part of the definition involves the interaction with the OSM transport. This specifies how we get messages into and out of OSM. This operation is divided up into three phases; the method of establishing a connection, the method of conducting a session, and termination actions. These definitions include any API interactions.

When we are satisfied with our definitions, we generate the specification. The specification consists of two parts; protocol implementation and transport interface. The PDL compiler generates these specifications (modules) and stores them in the Protocol Definition Repository (PDR) and Transport Interface Repository (TIR) respectively. Once these have been generated, we specify the end-point information in the End-Point Resolution Table (EPRT) and add OSM to the Distribution Priority Table (DPT), and set it as the preferred protocol for the interface defined in MDR. The interface was already defined in the MDR, only we were using XX rules to marshal any interactions.

If TUBE wasn't aware of the interfaces used over XX, then the IDL compiler would need to be run to import the interface definitions and the XX clients would need to be pointed to a TUBE XX module. This allows TUBE to intercept the client calls, while the clients still believe they are talking to an XX server. The bank can now exchange messages over OSM using its existing XX-based clients. No modules required modification. The only changes were at a configuration level. Anytime an XX-based message is intercepted by TUBE, the OSM-PIM and OSM-TIM are invoked by DAM and TMS respectively to marshal and send messages via OSM.

Before the bank makes the significant investment of actually implementing its “secret” protocol, they would like to test out its robustness and resilience to attack.

They are able to do this using TUBE as the implementation. All they need to implement is the encryption library, which TUBE will call during marshal and un-marshal operations. This way their algorithm remains secret. TUBE is unaware of its detail or structure. It merely handles the (potentially) complex traversal of the interface definitions. Usually these would have to be hand-coded for each interface. TUBE saves the bank a vast amount of work.

With traditional middleware and EAI tools: new connectors fully implementing OSM would need to be developed for every interface that would be processed.

New Protocols cannot simply be defined and “virtually” implemented. Protocols must be fully implemented end-to-end. Using TUBE the bank is able to: test-drive its new protocol before investing in complete implementation, choose whether or not to physically implement OSM in its servers or clients, revert back to XX at anytime by a simple configuration change, set-up redundancy by using TUBE's protocol alias and prioritization features venable clients of any protocol (e.g. web-based SOAP clients) to access services supplied by OSM. TUBE handles the SOAP to OSM conversion future-proof its clients and servers from middleware changes. Coding is only required if the bank wishes to change the functionality of its clients or servers. Using TUBEs' rule engine may even alleviate that requirement

TUBE uses a modified IDL style language (Protocol Definition Language or PDL) to define protocols. This PDL definition is compiled into a set of binary op-codes. This collection of op-codes is known as a Protocol Implementation Module (PIM). The Dynamic Adaptive Marshaller (DAM) is a virtual machine, which loads and executes the op-codes in the PIM at run-time. The op-codes in the PIM contain instructions for traversing the interface definitions stored in the Module Definition Repository (MDR).

These definitions are obtained by parsing the IDL description for the interface.

Constructs defined in the script, which are not part of the message payload (for example the header) are stored in a run-time variable segment and only used for same-protocol exchanges. The items that constitute the body of the message (as defined in MDR) are stored in an intermediate format known as a TLV (Type, Length, Value) buffer. When marshaling an out-bound (target) message, the values are obtained from the TLV buffer.

The novel features that are considered characteristic of the invention are set forth with particularity in the appended claims. The invention itself, however, both as to its structure and its operation together with the additional object and advantages thereof will best be understood from the following description of the preferred embodiment of the present invention when read in conjunction with the accompanying drawings. Unless specifically noted, it is intended that the words and phrases in the specification and claims be given the ordinary and accustomed meaning to those of ordinary skill in the applicable art or arts. If any other meaning is intended, the specification will specifically state that a special meaning is being applied to a word or phrase. Likewise, the use of the words “function” or “means” in the Description of Preferred Embodiments is not intended to indicate a desire to invoke the special provision of 35 U.S.C. §112, paragraph 6 to define the invention. To the contrary, if the provisions of 35 U.S.C. §112, paragraph 6, are sought to be invoked to define the invention(s), the claims will specifically state the phrases “means for” or “step for” and a function, without also reciting in such phrases any structure, material, or act in support of the function. Even when the claims recite a “means for” or “step for” performing a function, if they also recite any structure, material or acts in support of that means of step, then the intention is not to invoke the provisions of 35 U.S.C. §112, paragraph 6. Moreover, even if the provisions of 35 U.S.C. §112, paragraph 6, are invoked to define the inventions, it is intended that the inventions not be limited only to the specific structure, material or acts that are described in the preferred embodiments, but in addition, include any and all structures, materials or acts that perform the claimed function, along with any and all known or later-developed equivalent structures, materials or acts for performing the claimed function.

### BRIEF DESCRIPTION OF THE DRAWINGS

FIG. 1: is a diagrammatic view of the TUBE build time processing system in accordance with one embodiment of the invention;

FIG. 2 is a diagrammatic view of TUBE Component Architecture of one embodiment of the middleware broker of the invention;

FIG. 3 is a diagrammatic view of TUBE out-bound message scenario;

FIG. 4 is a diagrammatic view of TUBE in-bound message scenario;

FIG. 5: is a diagrammatic view of Fragment of mathServer IDL

FIG. 6: is a diagrammatic view of Structure of request message (highlighting payload)

FIG. 7: is a diagrammatic view of Structure of a successful response message (highlighting payload)

FIG. 8: is a diagrammatic view of Structure of an unsuccessful response message with an exception as payload

FIG. 9: is a diagrammatic view of structure of a PIM

FIG. 10: is a diagrammatic view of structure of a PIM Header

FIG. 11: is a diagrammatic view of structure of a Marshalling Map

FIG. 12: is a diagrammatic view of mapping op-code target to variable value

FIG. 13: is a diagrammatic view of declaration of a byte Sequence

FIG. 14: is a declaration for an array

FIG. 15: is a declaration of a null terminated string

FIG. 16: is a declaration of an object reference

FIG. 17: is a control clause

FIG. 18: is a response message declaration showing buffer_length variable

FIG. 19: is a diagrammatic view of the process of invoking DAM from a PCM

FIG. 20 is a PDL definition of CORBA using the PDL compiler of the invention;

Table 1: State Parameter entry

Table 2: Structure of a (Code) State-Block

Table 3: Format of Constant Segment Entry

Table 4: Format of Variable-Definition Segment Entry

Table 5: In-memory layout of Variable Value Table

Table 6: Extensions to OMG IDL

Table 7: TUBE internal variables

Table 8: op-codes generated for reading a byte Sequence

Table 9: op-codes for reading a null terminated string

Table 10: op-codes for reading an object reference

Table 11: Op-codes for processing “control” clause

Table 12: Post-Marshal map for CORBA message

Table 13: PDL Op-codes

### DESCRIPTION OF THE PREFERRED EMBODIMENT

Referring to the drawings and tables there is shown a method of intercommunication of middleware including the steps of providing a table of initial definition of structure characteristics, including format and parameter data types, of one or more protocols; converting said one or more structure protocol definitions into a selected format; storing said one or more structure protocol definitions in said selected format in one or more repositories; and at run time assessing the incoming message and selecting an appropriate structure protocol definition to be used from the table and using the selected format of the converted structure protocol definition to communicate.

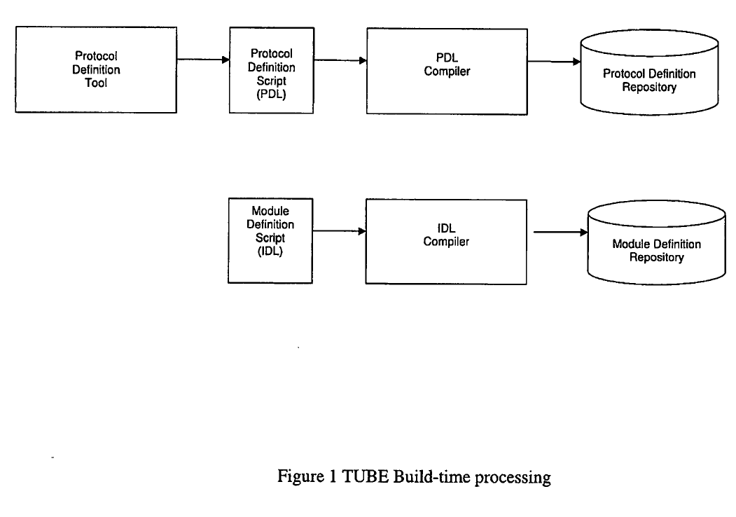

As shown in FIG. 1 middleware broker of the invention includes The Ubiquitous Broker Environment (the TUBE system) which uses PDL (Protocol Definition Language), and a declarative scripting language (based on OMG-IDL) to define the characteristics of a particular protocol. The TUBE Protocol Definition tool provides a GUI interface for users to produce PDL scripts. This script is then submitted to the PDL compiler, which converts it into an internal format that TUBE can process at runtime. The output of the PDL compiler is stored in the Protocol Definition Repository. The TUBE Interface Description Language (IDL) compiler processes the IDL definition of the interfaces that need to communicate. These files define the format and data types of the parameters passed between clients and servers. TUBE stores this information in its Module Definition Repository. This data in conjunction with the protocol definition (stored in the Protocol Definition Repository) is all that TUBE needs to convert messages between different middleware formats.

The Distribution Priority Table stores the names of the various protocols supported for each interface defined in the Module Definition Repository. These protocols are stored in priority order; that is, starting by the preferred protocol, followed by each subsequent protocol. Each entry in the Distribution Priority Table corresponds to an entry in the End-Point Resolution Table. This table defines the communication parameters necessary to communicate with the interface over the specified protocol. In the case of CORBA, for example, this would be the IOR for a server that implements the desired interface. The information stored here depends entirely on the protocol. These two tables are used in conjunction by TUBE to determine where and how to send messages between different middleware.

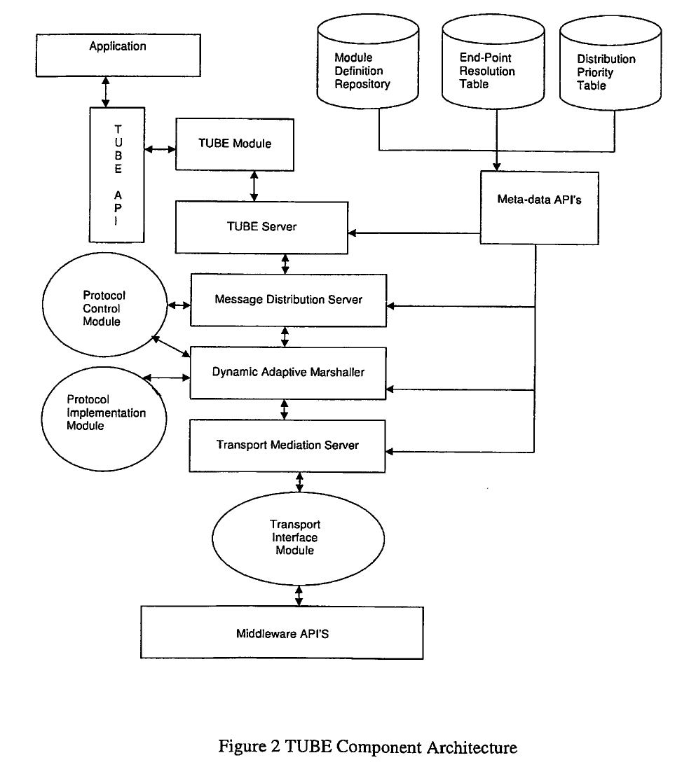

FIG. 2 shows the main components of the architecture of The Ubiquitous Broker Environment (TUBE). Systems that work through TUBE will use the TUBE API, or use their own middleware API, and have these calls intercepted and processed by TUBE. TUBE consists of four (4) main process components, in addition to its four (4) repositories.

The TUBE server provides the entry-points for the APIs. Both client code and TUBE internal code communicate through the interfaces provided.

The Message Distribution Server (MDS) associates each request for a service with a particular protocol. It reads the Distribution Priority Table to determine which protocol to use to process the message.

The Dynamic adaptive marshaller (DAM) prepares requests for a particular protocol. Given a request from the MDS, it looks-up the definition of marshalling rules for the requested protocol, and the target interface definition in the Module Definition Repository. It then marshals the target interface into the desired protocol, based on the definitions from both repositories. It also un-marshals from the source protocol into an internal protocol-neutral format.

The Transport Mediation Server (TMS) determines the target end-point for the interface from the End-Point Resolution Table. It uses the combination of interface and protocol, such as the IP-address and port number of an ORB, to workout the destination.

The Module Definition Repository (MDR) stores the meta-definition of the particular interface. This includes the interface identifier and the data types of the parameters passed. This information is derived from the IDL for the interface.

The Distribution Priority Table (DPT) provides for each interface defined in the MDR, a list of protocols that can be used to communicate with this interface, stored in priority order.

The Protocol Definition Repository (PDR) stores the marshalling rules for each protocol. These rules are generic for each protocol and not specific to any interface stored in the MDR.

The End-Point Resolution Table (EPRT) stores the target communication address for each interface/protocol combination. This address could be, for example, the IOR for a CORBA server, or a queue definition for MQ series. This table stores the necessary information to send a message to, or communicate with, a defined interface using a particular protocol.

The protocol structure undergoes a language neutral machine independent definition and is compiled into binary modules known as protocol implementation modules (PIMs) and transport interface modules (TIMs). The TIMs contain the communication parameters.

These PIMs and TIMs are loaded at runtime and executed by interpreters (virtual machines). PIMs are processed by the dynamic adaptive marshaller (DAM) and the TIMs are handled by the transport mediation server (TMS). Both of these modules are controlled by the message distribution server (MDS). The MDS is also responsible for any interface mapping that is required. It uses either the processed request or response message and a mapping definition. The actual mapping is performed by a mapper module under the direction and control of the MDS.

TUBE uses different data formats internally depending on the situation. In the diagrams the Protocol Independent Data Streams (PIDS) are the format used internally to pass data between the TUBE API, the server and the DAM components. The Protocol Oriented Data streams (PODS) on the other-hand consist of data that has been marshalled into a protocol-specific format (e.g. CORBA) by DAM. These are passed internally between DAM, the MDS, TMS and, if required middleware-specific APIs.

TUBE provides the ability to use either or both synchronous and asynchronous communication modes, and that the desired method can be changed at anytime without system impact. When it is required to switch from one mode to the other, all that is required is to change the configuration. This can be done on a per module/interface basis, even while the system is running. There is no need to shutdown and re-start the broker.

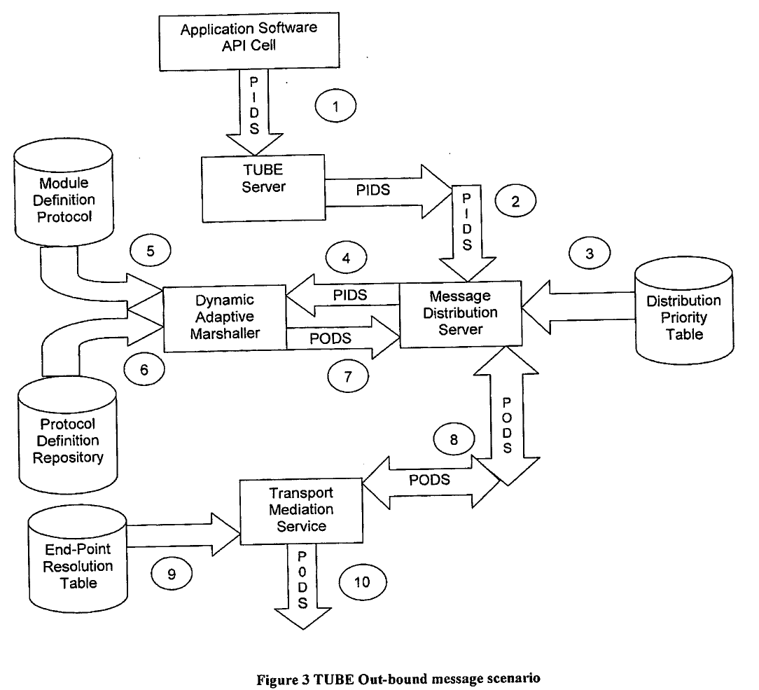

The following scenario depicted in FIG. 3 describes the process-flow of an out-bound message through TUBE through the following steps:

The application call is passed to the TUBE API via the TUBE server.

The TUBE server passes the call to the Message Distribution Server.

The Message Distribution Server selects a protocol to try from the Distribution Priority Table.

The Message Distribution Server passes the interface/module identifier and the preferred protocol to the Dynamic adaptive marshaller.

The Dynamic adaptive marshaller reads the Module Definition Repository to determine the format and arguments for the call.

The Dynamic adaptive marshaller uses the protocol definitions stored in the Protocol Definition Repository to prepare the call for the particular middleware or application service.

The Dynamic adaptive marshaller passes the marshalled buffer back to the Message Distribution Server.

The Message Distribution Server passes the marshalled message to the Transport Mediation Server and tells it which protocol to use for transmission.

The Transport Mediation Server reads the End-Point Resolution Table to determine the host and port number required to communicate over this protocol.

The Transport Mediation Server attempts to communicate with the designated host using the appropriate communication parameters.

If communication with the preferred protocol fails, TUBE will try each subsequent protocol (in priority order). The application will only receive notification of communication failure once all the listed protocols have been exhausted. If communication succeeds, TUBE sends a positive notification to the application. The way that this occurs depends on the application's relationship with TUBE. If the application has invoked TUBE via the API, then TUBE will return the status directly to the application. If, on the other-hand, TUBE has intercepted an out-bound call made by a proxy or stub, then the status will be given to that module for return to the application.

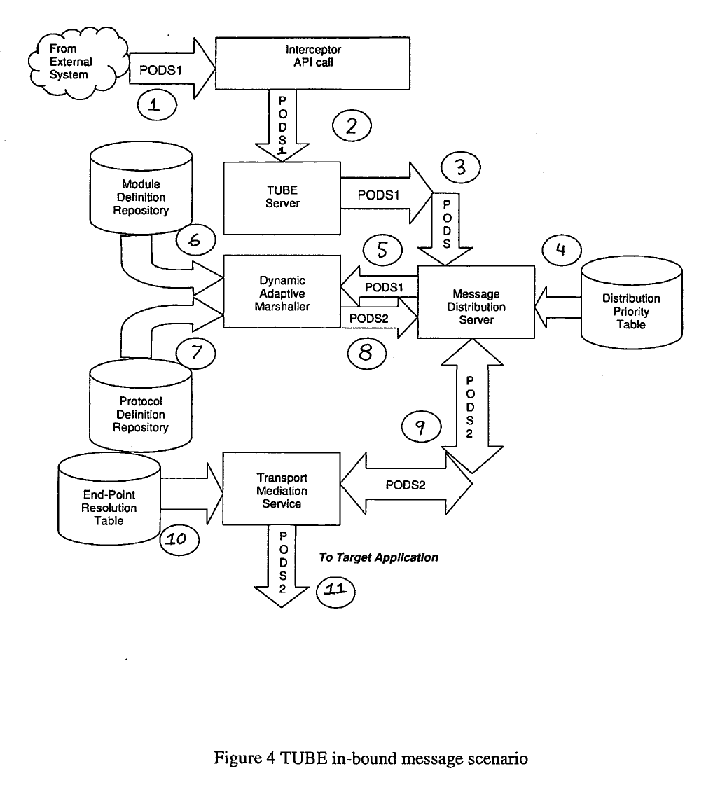

The scenario shown in FIG. 4 describes the process-flow of an in-bound message through TUBE with the following steps:

the external call is intercepted by a TUBE module.

the interceptor uses the TUBE API to pass the message to the TUBE server, which passes the call to the Message Distribution Server.

the TUBE server passes the message to the Message Distribution Server in the protocol that it was received.

the Message Distribution Server looks-up the Distribution Priority Table to determine whether the message needs marshalling into another protocol.

Steps 5, 6, 7 and 8 are only executed if the protocol needs to be converted by the Dynamic adaptive marshaller. If not then the message can be passed through to Step 9.

The Message Distribution Server passes the interface/module identifier and the preferred protocol to the Dynamic adaptive marshaller.

The Dynamic adaptive marshaller reads the Module Definition Repository to determine the format and arguments for the call.

The Dynamic adaptive marshaller uses the protocol definitions stored in the Protocol Definition Repository to prepare the call for the particular middleware or application service.

The Dynamic adaptive marshaller passes the marshalled buffer back to the Message Distribution Server.

The Message Distribution Server passes the (possibly converted) message to the Transport Mediation Server and tells it which protocol to use for transmission.

The Transport Mediation Server reads the End-Point Resolution Table to determine how to contact the end-point for this protocol. In this case, it determines that the end-point is local.

The Transport Mediation Server then passes the message to the “Target Application” on the local system.

It can be seen that the middleware broker of the invention using The Ubiquitous Broker Environment (TUBE) aims to provide protocol-level inter-operability with the following characteristics:

Supports a wide range of protocols, including legacy systems.

Protocol descriptions are to be declared, and developed with a utility tool supplied with TUBE. This allows new protocol support to be added with no impact on existing systems. This effectively provides future-proofing of IT investments. As new protocols emerge, they can be utilised declaratively with very little (if any) development.

Protocols can be changed (added or removed) without re-compilation of application software.

From a user perspective, a major advantage of this approach is that application programs don't have to be re-compiled to use TUBE. TUBE is installed, and descriptions of the protocols supported are declared and stored in a protocol definition repository. Applications specify the service that they want by using the API of the service. These calls are intercepted by TUBE, which determines a service provider and marshals the call appropriately. The service providers and the protocols that can satisfy a call are specified for each interface. If the required service is not available through a preferred protocol, then alternative protocols are tried. For example, the default may be CORBA, and calls will target CORBA end-points (e.g. an IOR); however, an alternative may be MQ-Series, which will be tried if a CORBA service cannot be reached. (The onus will be on the systems integrator to specify those protocols that are interchangeable for each interface.)

Unlike some proprietary EAI products, which attempt to control workflow and broadcast (publish) each message on a universal messaging bus, TUBE only communicates with designated end-points. TUBE is capable of broadcasting or publishing to a universal bus, if that is required. Since TUBE will provide fully synchronous or asynchronous methods, the desired communication type may be changed at anytime without system impact. For example, if synchronous behaviour is required from an (essentially) asynchronous middleware platform (e.g. MQ-Series), TUBE will handle the synchronisation through blocking and buffering. If it is then required to go back to purely asynchronous, the application software does not need to change, provided that the protocol is supported for the called interface. This will allow remote modules to be developed independently, and for each to use the middleware that best suits their purposes. There will be no need for independent development groups to be familiar with each other's protocols.

The messaging life-cycle employed depends upon the type of communication mode we are engaged in. If we are engaged in a synchronous mode operation, then we will be in a blocked or waiting state. In the asynchronous mode, we are also waiting but can continue to perform other tasks whilst we wait. We need to be able to handle both modes independently of one another, and also be able to combine them. Let us consider the following example, a client may make a synchronous request on a server using the same protocol as always; the client is unaware that the server implementation has been changed to use asynchronous queuing. We need to hold the synchronous session with the client, which is awaiting a response and is thus blocked. At the same time we must monitor a queue on the server-side and we must wait for a response that could come at anytime. However, we are not blocked, we are waiting to be notified when something is put on the queue. When our response arrives we send it back to the waiting client. This entire process involves more than sending and receiving of the request and response; we must marshal the data to and from the source and target protocols.

During the marshalling process the message data need to be buffered and copied from the source to the target. Depending on message size, this could be a fast or slow task. If we are brokering a synchronous request over an asynchronous invocation to the server, we will keep the client blocked until we have completely marshalled and sent the request message. The client will continue to remain blocked until we return the response to it.

The component in the TUBE architecture that is responsible for managing the messaging life-cycle and ensuring that clients either; receive the response in synchronous mode or are notified of responses in the asynchronous mode is the Message Distribution Server (MDS). The MDS is the first and last module to handle a message and its subsequent response (assuming a two-way exchange). The MDS is also responsible for determining the target end-point from the DPT and EPRT, and providing that to the other modules via an API. When clients elect to use the TUBE server directly via APIs, the TUBE server creates an instance of MDS to handle the message. The same thing occurs when a protocol interceptor intercepts a message; it uses an instance of MDS to manage the session.

The basic operation of MDS may be described as follows:

Receive an in-coming message

Invoke the DAM to un-marshal the source message into protocol-neutral (TLV) format

Determine the target protocol and end-point from the DPT and EPRT

Call DAM to marshal from the TLV format into the target format

Invoke the TMS to perform the actual communication and await the response

There are some situations where the semantics required by a particular protocol cannot be handled by MDS. The job of the MDS is primarily to distribute messages amongst other TUBE components to ensure that they are marshaled and delivered correctly. This generic model would be compromised if we tried to build the logic into MDS to handle these very protocol-specific situations. Instead we relegate these protocol-specific tasks to what we call “Protocol Control Modules”. The PCM assists the MDS with higher-level semantics that deviate from the standard synchronous and asynchronous communication modes. An example of this is the LOCATION-FORWARD response received in CORBA.

This response tells the client to resubmit the original request to a new target end-point. We chose not to embed the logic to handle this in MDS. This is a very CORBA-specific situation and it did not make sense to design any specific protocol related operations into MDS. Had we done so, we would have most likely found ourselves adding logic to handle the idiosyncrasies of other protocols. This would endanger MDS of becoming over complicated and difficult to maintain as new protocols were added. A major design goal of MDS, and for that matter all of TUBE, is to be protocol-neutral. The only parts that are intended to be protocol-specific are the PIMs generated from the PDL scripts. The MDS uses the PCM to make higher-level decisions about message processing. The MDS will pass the full request or response to the PCM and will delegate all further processing to it. MDS will wait for the PCM to either submit another request or return a response to the client.

Protocol definition language (PDL) as its name implies is a language (symbolism) for defining protocols. In the same way as IDL defines interfaces, PDL defines protocol structure. The language defines the structure of both request and response messages. When we say it defines the structure, we are referring to the things that we need defined in order to exchange messages with a server on behalf of a client. We discuss earlier in the paper that the purpose of TUBE is as a broker between disparate systems. As a broker, it sometimes needs to convert from one client protocol to another to communicate with a server. We have various types of protocols; we have text-based protocols such as XML, HTTP and SOAP. (This is not character-set conversion such as ASCII to EBCDIC, rather conversion of numbers to strings and so on) Then we have binary protocols, some of which are object-based (examples include CORBA, COM and Java-RMI) and others such as DCE-RPC, which are not object-based. Finally, we have the MOM type protocols such as MQ and JMS. Each protocol wraps or encapsulates the actual message content in different ways. SOAP for example wraps the content in a structure called a SOAP body, and then wraps this in another structure known as a SOAP envelope. In the following discussion, we shall refer to this content as the payload. This is the body of the message as defined for the interface.

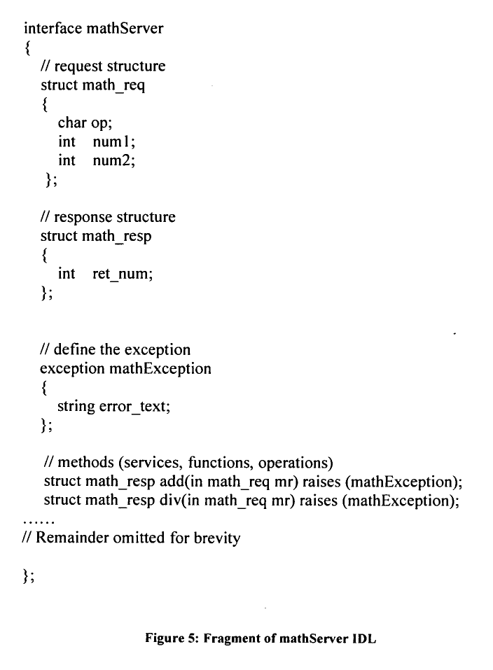

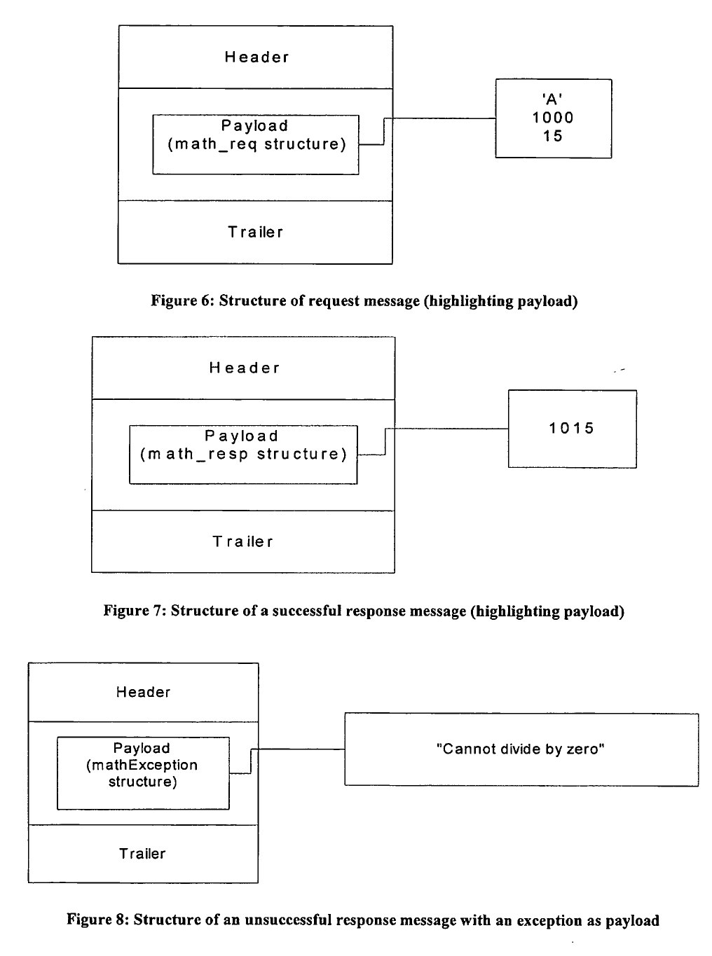

To clarify this, let us use our simple math-server definition again; partially reproduced in FIG. 5 for convenience of the reader. FIG. 6 and FIG. 7 show the basic structure of a request and successful response message for an “add” operation of the numbers “1000” and “15” on the mathServer interface. The server may also return an exception or error condition. This is shown in FIG. 8, where we assume that the div (divide) operation was called with “1000” and “0”. This is an illegal operation and hence the server returns an exception. The exception we have defined is a structure, which contains one member, a string describing the error. It could however be considerably more complex. The example exception shown is protocol-neutral, that is, it does not represent any specific protocol mapping. It is merely illustrative.

Referring to the interface definition above, if we are dealing with a request, our payload will be a math_req structure (see FIG. 6). If we are dealing with a response, we will have a math_resp structure (see FIG. 7) or some failure indication (see FIG. 8). The payload for a message is either the (serialized) input parameters to the operation, or the (serialized) response from the operation, whether successful or not. We know from the above definition how to marshal these structures; we know at least what native types constitute them. What we do not know however, is how to marshal them over a particular protocol. Do we want the integer (int) values converted to text so we can send them in XML? Does the protocol wrap the payload in some other structures, such as headers or trailers? If we only know the structure of the interface, then we cannot broker between protocols. We must know what to add to the message or what to convert (this is not character-set conversion such as ASCII to EBCDIC, rather conversion of numbers to strings and so on) so that the target system can receive and process it. We must also know the address (in protocol-specific terms) of the end-point (target). This may be a host name and port number or a queue name or, perhaps a directory name. These are the items of “protocol structure”, which PDL is designed to address.

There are also certain aspects of message structure, which are similar although not the same between protocols. That is, they may contain varying values depending on the protocol, or appear in different places within a message. These items are mandatory for any message exchange regardless of protocol. We refer to such items as TUBE internal variables. These are the variables TUBE uses to keep track of such things (amongst others) as; message lengths, sequence numbers, and whether we are dealing with a request or a response.

Table 7 provides details of all these variables. In the discussion that follows, we refer to TUBE internal variables and user variables. User variables are those that only have meaning for the particular protocol. We obtain their value from the EPRT entry for the interface. Although the variable is applicable to the entire protocol, its value is determined on an interface-by-interface basis. In other words, the same variable may have a different value in each EPRT entry. An example of a user-defined variable in an EPRT entry is a CORBA object-key. This identifies the object to instantiate (or invoke) on the target end. We discuss both types of variables and their PDL definition later.

Before this discussion, it is important to gain an understanding of some terms and concepts that we refer to when describing PDL. Of particular importance are code-blocks and op-codes. A code-block, also referred to as a state-block (see Table 2) is a structure consisting of the following elements:

Op-code

A target variable to store the result of the operation

Array of parameters for the operation

Offsets into other data structures required by the operation

These code-blocks are processed at runtime by a Virtual Machine (VM), which interprets the op-codes and executes the given instruction. We call this VM the DAM (Dynamic adaptive marshaller). We decided that using a VM would enable the addition of functionality to PDL by expanding the range of op-codes.

The op-code is a symbolic value used to determine the operation to be carried-out. For example, the op-code READ_INT instructs the marshaller to read a signed 32-bit numeric value from the input source. Likewise, the op-code WRITE_INT instructs the marshaller to write a signed 32-bit value to the output target.

The PDL is a series of extensions to OMG IDL. The rationale behind extending an existing language is that most software engineers have some exposure to, or knowledge of it. This is mostly the case with IDL. It defines CORBA interfaces and is the description language for Java RMI. OMG IDL itself is an extension of the original DCE RPC IDL. Microsoft also has a language based-on extension to RPC IDL called MIDL (Microsoft Interface Definition Language). It primarily defines C++ COM interfaces. Extending an existing language reduces the learning curve for the users, and shortens the development time for the PDL and supporting tools. An example of PDL is explained later with reference to FIG. 20. The example uses CORBA IIOP V1.0 to illustrate in detail:

The use of the IDL extensions

How the PDL compiler interprets the extensions

The op-codes that are emitted

In a later section we discuss the DAM, and show how DAM interprets these op-codes to handle messages.

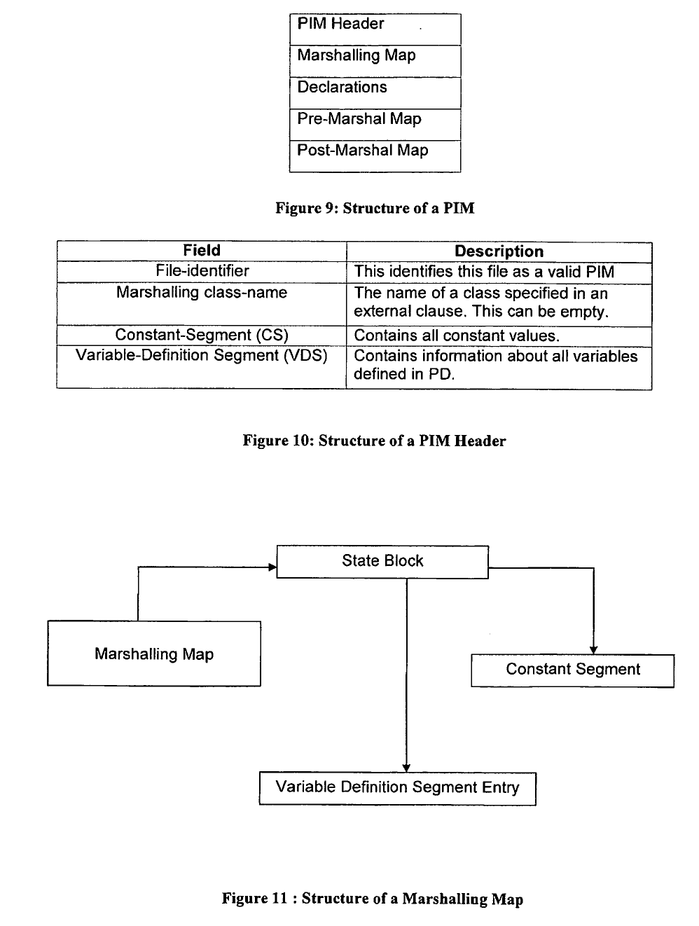

In the PDL compiler, PDL scripts are not compatible with IDL and therefore standard IDL compilers cannot process them, as they would not recognise the extensions, which would cause parsing errors. We need a special compiler to process PDL. The PDL compiler reads the PDL definition (also referred to as a script or PD) and generates two types of output, a Protocol Interface Module (PIM) and a Transport Interface Module (TIM). There are two PIMs generated for each protocol definition, one for handling requests and the other for handling responses. This simplifies the logic required in both the compiler's code generator and the runtime interpreter (DAM). The DAM loads the appropriate PIM based-on the current message type (i.e. request or response). The PIM is comprised of code-blocks, derived from constructs within the PDL script. For example, for each “struct” keyword encountered in the PD, the compiler generates what we refer to as a code-block. This code-block is a series of instruction blocks. An instruction block consists of op-codes and state definitions, which define operations, variables (internal and user-defined) and initial values. Each op-code and state is (generally) associated with a source or target variable. The FIG. 9 diagram illustrates the structure of a PIM.

The PIM header contains information and structures that assist in the loading and processing of the rest of the file. The header is comprised of the fields shown in FIG. 10.

We will deal with each of the header elements in turn, and then discuss the other portions of the PIM structure. The entire PIM structure and all the constituent parts are shown in the tables and explained as we encounter them.

The File-Identifier is a hexadecimal value, which identifies this file as a valid TUBE PIM. If this value is not found or does not match, then the rest of the file is ignored and the load aborted.

The Marshalling class-name specifies the name of the class that implements the TUBE.commsBuffer interface. This is the class that will be used for all reading and writing operations whilst processing this PIM. The actual disk layout of this item is an integer specifying the length of the name string, followed by the string. This string contains the actual name. A length of zero (0) signifies an empty class-name and there is no string following. In this case, the DAM will use a default (internal TUBE) implementation for encoding and decoding of native values.

The Constant-Segment stores all constant values. The entries specify a type, the length of the value and the actual value. We always encode the value in a byte array despite the data type. The compiler encodes offsets into this segment into instructions that require access to these values.

The Variable-Definition Segment contains information about all the variables defined in the PD. It stores the name, data type and a flag to define the variable as an internal or user-defined variable. If the variable has an initial value specified by an “init” clause (see Table 6), then an index into the CS is also stored.

The Marshalling map, Pre-Marshal map and Post-Marshal maps all have the same basic structure (illustrated in FIG. 11). These blocks contain the op-codes and other information necessary to the execution of the operation. The Declarations section of the file contains pointers into these maps for instruction-blocks generated from “declare” (see FIG. 13) statements. These blocks contain all the code required to handle the declared type. We now discuss variable handling and explain these relationships.

When the compiler encounters a simple (native) type in a struct definition, if it specifies an initial value, the compiler generates an entry in the CS and stores an offset to this value in a state-parameter entry (see Table 1). The compiler adds the entry to the state-block it is currently generating. If the variable does not have an initial value, the compiler generates a VDS definition as an empty slot for the value. This slot is a placeholder for the value when it is read-in. It is also the source for the value when writing. Refer to Table 5 for a description of the runtime usage of this entry.

In the case of compound (declared) types, the compiler generates references to two separate code-blocks, one in the reading PIM and one in the writing PIM. These code-blocks have a type of USER-DEFINED and have an entry created in the Declarations section using the name of the structure with either a “_READ” or “_WRITE” appended. This modified name is stored in the CS and the CS index is stored in the definition entry. The PDL compiler patches offsets to the actual code-blocks once it has completely processed the PDL script. The instructions to handle the declared type are generated into the Marshalling map. The first instruction-block for handling this type contains a pointer to the modified name in the CS. This is how the compiler finds the value to patch into the declaration entry. This is also, how the DAM identifies and loads individual code-blocks at runtime.

We write the Constant-Segment to disk in its entirety. It is read-only at runtime. These values never change during the execution of the PIM.

The compiler writes the Variable-Definition Segment to disk in the format shown in Table 4). This is what the DAM reads when loading the PIM. At runtime, we create another structure for storage of variable values for efficiency. We call this runtime-only structure the Variable Value Table (VVT). The layout of the VVT appears in Table 5.

The Variable Value Table stores the values for variables as we read them from the input source. If we are marshalling this value, then we use this entry as the source and write the current value to the output target using either, user-supplied methods or internal (default) handlers. We extract the native type from the Object wrapper for writing and we coerce it from the native value into the wrapper when reading. This casting of native types to and from objects adds some processing overhead, however we compensate for this with the ability to handle all data types in the same manner. Refer to the section on DAM for a more in-depth discussion on runtime variable management.

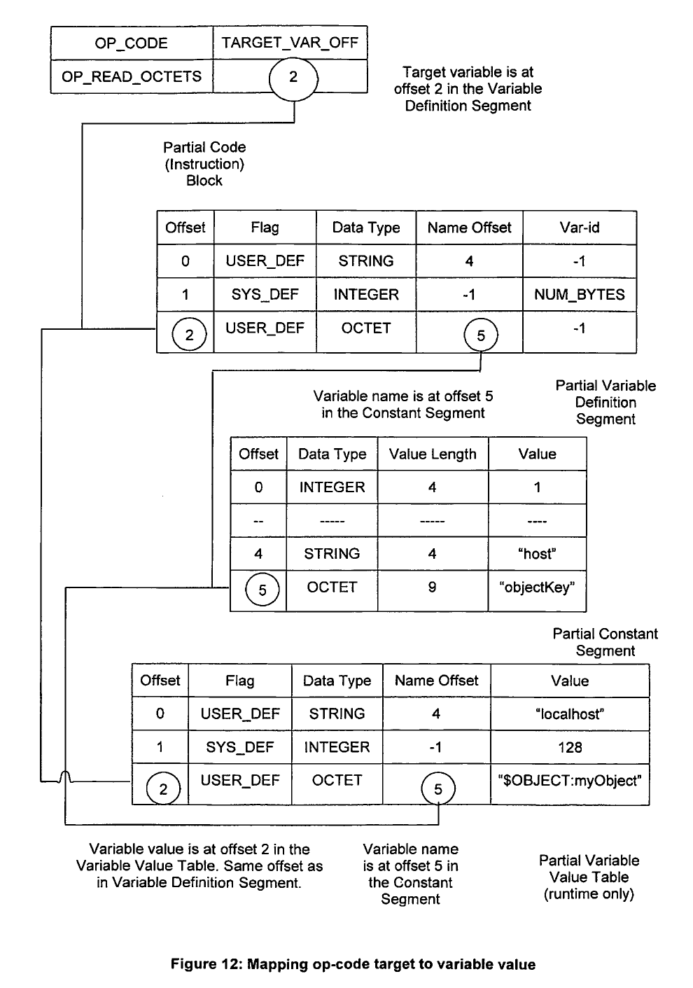

FIG. 12 illustrates a read-octet operation for a target variable, which has an offset of two (2) in the Variable-Definition Segment. If we follow this offset, the VDS entry stores an offset of five (5) into the CS. This is where we find the name of the variable “objectKey”. Because this is a USER-DEFINED variable (indicated by the declaration “$objectKey$” in the PDL script in the FIG. 20 CORBA example), initially we obtain this value from the EPRT entry for this interface. This entry then remains constant for the life of the PIM, unless explicitly changed by invoking set method or executing a code-block. When we have read the value, it will be stored in offset two (2) of the Variable Value Table (VVT). We create this table only at runtime to manage the storage of actual values, which are not constants. After the read, the entry at offset two (2) contains the value “$OBJECT:myObject”. When we marshal this in a request, its value comes from this VVT entry.

In the application of extensions to OMG IDL, table 6 shows the new keywords and constructs introduced to extend OMG IDL. A brief description of each is also given. We expand these descriptions as we work through our CORBA example.

Table 7 describes the internal TUBE variables that may appear in a PDL definition. The entry referred to in the text, unless otherwise noted, is a record in the Variable-Definition Segment.

These are reserved words and are expected enclosed in the ‘%’ character (e.g. % count %). The PDL compiler throws an exception if it encounters any other usage.

We will now examine each section of the PDL script (see FIG. 20 CORBA example) in detail. We also assume throughout the discussion that the compiler has built a symbol table and other internal structures during the parsing phase. Our discussion will concentrate on the code generated from these constructs, rather than their actual construction. Most of the examples show the instructions generated for reading. We must note that for each set of read instructions generated, there is also a corresponding set of write instructions emitted.

We begin with the protocol declaration.

protocol CORBA
{

The first keyword that we encounter is “protocol” followed by the value “CORBA”. This tells the compiler to generate the following two filenames:

CORBA_Req.PIM—defines rules for marshalling requests

CORBA_Resp.PIM—defines rule for marshalling responses

The “{” character identifies this as the opening of the PD script.

Next, we encounter three “typedef” statements. These behave the same way in PDL as in standard IDL and programming languages such as C and C++. In that, they define an alias for the type. For instance, the following statement;

“typedef sequence<octet, 3> reserved;”

causes the compiler to create a variable named “reserved” and whenever it encounters this variable to point to a code-block. The code-block will define op-codes for reading and writing a sequence of three octets. The definition for GIOP_MAGIC is very similar except that it also generates a four-byte entry in the CS with the value ‘G″I″O″P’. Whenever we begin to read a message, we first look for those four bytes and conversely, when writing a message we always write this initial value. The definition for “olist” specifies an octet sequence of unbounded length. The important distinction to note here is that sequences of native items (such as octets) defined with “typedef” do not have their length encoded and neither do we expect to read the length during decoding. If the length is required when reading or writing, we must define this using a “declare” clause (see byteSequence in above) as explained next.

Before we explain the “declare” clause however, we need to skip ahead a little and explain the “bufferFormat” construct and how the DAM uses it in conjunction with the MDR at runtime. The “bufferFormat” definition tells DAM, which code-blocks to use when marshalling the payload. The payload can be made-up of either native types or constructed complex types. The complex types may contain native types and other complex types. We must provide the DAM with marshalling instructions for the following standard constructed types:

STRING—how to marshall a String

BYTESEQ—marshall an arbitrary byte sequence

ARRAY—marshall an array (fixed-size sequence) of native or complex types

SEQUENCE—marshall a variable-length sequence of native or complex types

OBJECTDEF—marshall an object definition

The DAM assumes that a message may only be comprised of a combination of those items and native types. If we do not provide these instructions in the PDL, consequently there will be no handlers (code-blocks) generated, as there will be no “declare” clauses to define them. In this case, DAM will use internal marshalling rules, which may or may not be suitable for the particular protocol. For example, an object definition is very protocol specific. If none is given, DAM will simply encode and decode an item defined in MDR as an object, as an un-interpreted array of bytes. If we look at the PDL definition for an “objectDef” in our CORBA example, we can see that if we omitted the “declare” and “bufferFormat” statements, the default behaviour would not be suitable for our protocol. (For example, strings would not be null terminated.) If the PDL compiler encounters multiple bufferFormat statements, it throws an exception and terminates processing.

The next keyword we encounter is “declare”. We use this for defining compound or complex types, which may be composed of many native and or other, compound types.

Referring to FIG. 13 we are defining a “byteSequence”. This will generate op-codes that tell the DAM how to read and write an arbitrary sequence of bytes. We define a reference to an internal TUBE variable “% num_bytes %” (see Table 7: TUBE internal variables). This indicates how many bytes (octets) to read or write next. We then have a reference to an “olist”. Next we find the end of this declare clause, signified by “};”.

The compiler will now create a code-block named “byteSequence_READ” with the op-codes shown in Table 8.

From this point on wherever a reference to “byteSequence” appears, the compiler will encode an instruction to load this code-block and execute it. Any other code-blocks that refer to this code-block will have a flag set that specifies a reference to a “USER-DEFIND” code-block. The instruction (in the referring block) will also have an offset (in the CS) to the name of this block.

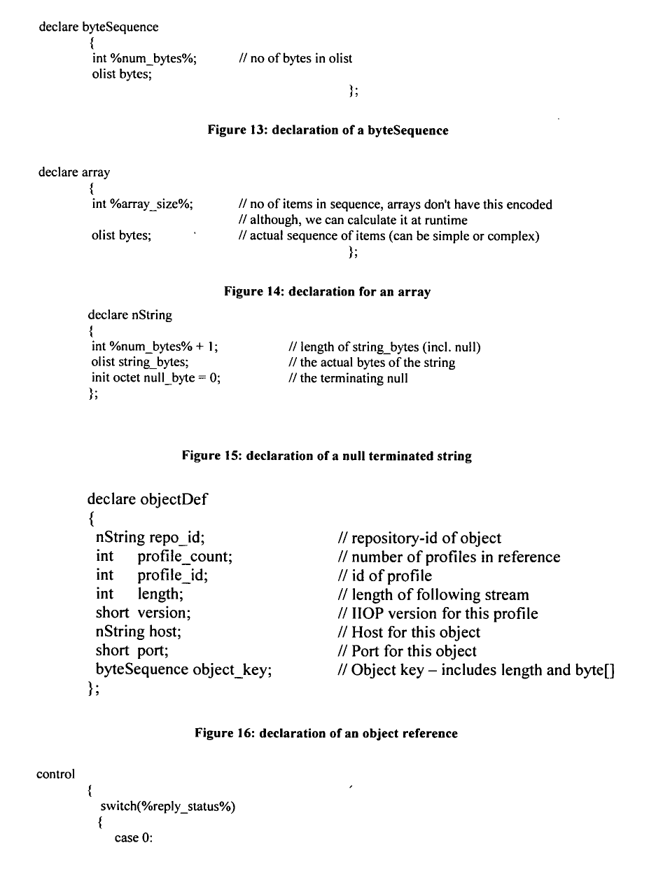

Referring to FIG. 14, the next declaration we encounter is for an array. This entry specifies how DAM should handle arrays. This is very similar to the byteSequence example, except that we use another special variable “array_size” to keep track of the number of actual entries. An array is a fixed-size sequence. The interpreter derives the upper-limit of the array dimension at runtime by referencing the MDR entry for the particular interface being marshalled. Currently PDL supports only single dimension arrays.

Referring to FIG. 15, the declaration for “nString” demonstrates the use of op-codes to add and subtract constant values to and from those currently being processed. The “+1” tells the compiler that we always have one extra byte than the actual string length. Here we read the length of the string including the null byte, and then we must subtract one (1) from it. This is so we do not consume the null as part of the string. We read it separately and discard it. Conversely, when we are writing the string, we first add one (1) to the length and write it. We then write the string itself, and finally we write the null byte.

The compiler generates the code-block as per Table 9.

Referring to FIG. 16, the “objectDef” declaration illustrates the usage of declared types within declared types.

Table 10 illustrates the resultant code-block.

The interpreter executes the instructions above whenever an “object” definition is encountered in the payload and the value being marshalled is defined as an “object” type in the MDR. The statement “OBJECT=objectDef;” in the bufferFormat clause defines this association.

The “bufferFormat” clause is the next construct that we encounter. As we have already explained the bufferFormat clause above, we will not repeat it here.

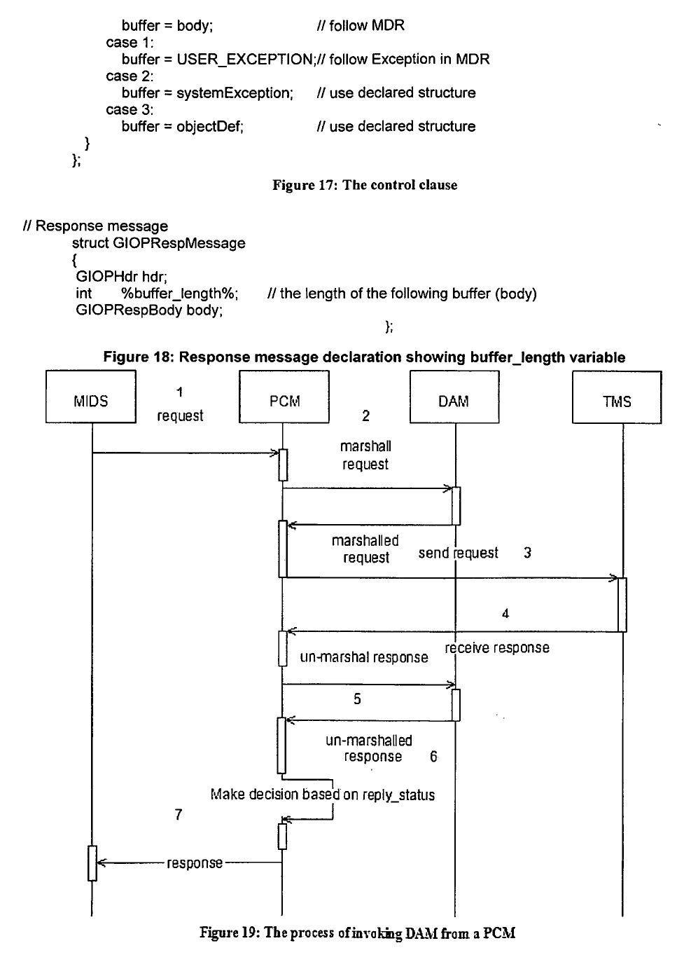

Referring to FIG. 17 the next significant construct we encounter is the “control” statement. The compiler writes the op-codes generated here (see Table 11) into the Pre-Marshal map. These are loaded and executed just before marshalling the payload. When the interpreter encounters the special op-code START_PAYLOAD, it will search for a pre-marshal map. If none is found, then the DAM will traverse the payload according to the MDR definition for the interface being processed. Otherwise, if there is a map present we invoke a module to handle the tests.

The statement above tells the compiler to generate some branching op-codes based-on the value of the internal variable reply_status. When the value of reply_status is read from the input at runtime it is examined and tested for the values: 0, 1, 2 and 3. The value determines what action to take for encoding or decoding the payload. After executing the appropriate action, we exit this module and return to the main interpreter code. According to the rules specified above, we will execute the following process:

If the value is zero (0) we push a false onto the stack. This indicates that we will follow the MDR definition for the interface and marshall the values accordingly. In this case, the module returns a Boolean false. If it is not zero (0) we then perform a test for one (1), and if this is true we follow the definition of the exception for this operation (as defined) in the MDR. Unlike the case for zero above where we return false, for MDR-defined exceptions we return true to indicate that it is not the standard payload; although, we are still following an MDR definition. Otherwise, we test for two (2), and if this is true, we push the name of the code-block defined as “systemException_READ” and return it. Finally, we test for a value of three (3). If this is true, we load the name of the “objectDef_READ” code-block and return. If none of the defined values exists, the DAM throws a marshalling exception.

In summary, the module that performs the “control” instructions returns one of three values to the main interpreter. It returns false if we are marshalling the payload by following the MDR representation, or it returns true if we must handle the payload differently. A string value indicates that this module has pushed the name of a USER_DEFINED code-block (that was defined with the declare clause) onto the stack. The main interpreter loop will load and execute this code-block. After marshalling the payload, the interpreter will search for a Post-Marshal map.

Table 11 shows op-codes for processing “control” clause. Unlike the control clause for pre-marshal maps, there is no keyword to indicate the start of a post-marshalling map. (We may introduce one or more if we feel it would add flexibility to PDL.) The compiler will always generate code to write-out the body (payload) length after marshalling the payload. Therefore wherever the variable % buffer_length % is encountered this tells the compiler that this is the payload length. We initially marshal the length as zero (0) and then we re-write it with the correct value after marshalling the body.

Referring to FIG. 18, statements that contain the buffer_length variable, such as the one shown, automatically cause the compiler to create a post-marshalling block. This block contains instructions to save the current point in the buffer, calculate the new position, write the length and return to the current position.

Table 12 shows post marshal map for CORDA message.

Next, we encounter the “external” clause. This defines the full class-name (including packages) of the class that the interpreter is to call for marshalling native types. Because CORBA uses CDR encoding for primitive data, the default TUBE codec is not suitable. Therefore, we define our own special class to handle the CDR padding of the bytes that the PIM reads or writes. We only need to define this class once in the PDL. From then on, it will be available for marshalling any defined interface across this protocol. For example, when the PIM contains a READ_INT op-code, the DAM will call MYORB.marshaller.CDRBuffer.read_int( ) to obtain the value. Conversely, when we encounter WRITE_INT, we call MYORB.Marshaller.CDRBuffer.write_int(value) to output the value. This clause causes the compiler to populate the Marshalling class-name member of the PIM header.

The final construct we shall deal with in this example is the “endPoint” definition. It appears in PDL as follows:

| endPoint : “TCP” | |
|---|---|
| { | |
| // | |
| // These are transport and protocol-specific items | |
| // | |
| “host”; | // This is the host for the object |
| “port”; | // This is the port on the host |
| }; | |

The value following the “:” is transport for the protocol, in this case “TCP” for IIOP. The DAM must find these values in the EPRT entry for this interface. The compiler generates code into the TIM for loading and using these values. As the definition for this endpoint defines the use of TCP/IP, the TIM will use these values to create a sockets-based connection to the defined host on the designated port. We cover the operation of TIMs in more detail in the section on the Transport Mediation Server (TMS).

In the next section, we will continue with our CORBA example and show how parts of the message may be re-marshalled.

The Dynamic adaptive marshaller (DAM) is the name we have given to the VM, or interpreter, which executes the PIMs that we discussed in the previous section. As the name suggests, this component must dynamically adapt to the protocol that it needs to marshal. Before we discuss the DAM in detail however, it is important to understand the two (2) types of invocation modes (i.e. the ways we invoke DAM).

We can invoke DAM in either of the following ways:

Via a Protocol Control Module (PCM)

Via the Message Distribution Server (MDS)

Both invocations actually occur via MDS, however in the case of a PCM, the MDS first routes to the PCM, which then invokes the DAM. In the other case, the MDS invokes the DAM directly.

Firstly, we must discuss the role of the Message Distribution Server (MDS) in the message processing cycle. We assume throughout the discussion, that we are processing a synchronous (two-way) message.

When a request is intercepted by a protocol listener, the listener creates an instance of MDS and passes it the message. The MDS will then attempt to create an instance of a Protocol Control Module (discussed below) using the Java Reflection API. If the creation is successful, MDS hands the request to the PCM and takes no further part in the process until the PCM returns the response. Whereas, if the creation fails: MDS passes the request to DAM and waits for DAM to return a protocol-neutral representation of the request (a TLV buffer). The MDS will now look-up the DPT to ascertain the target protocol. The MDS passes the TLV buffer back to DAM for marshalling into the target protocol. After DAM returns the marshalled request, MDS passes the message to TMS for transmission to the target end-point. The MDS now waits for TMS to return the response. When MDS receives the response, it carries out the reverse of the above procedure; it uses DAM to convert the response from the target protocol into the source protocol. The MDS returns the marshalled response to the listener.

A Protocol Control Module (PCM) is a piece of software written by a user. This module provides higher-level protocol semantics than those required for marshalling. As an example, consider our CORBA PDL definition (see). In this script, we have a “control” clause, which is a switch statement that controls what sort of message payload we are dealing with. The decision as to what to do with this payload after marshalling and return belongs to the PCM. The PCM implements the same switch logic as that specified in the control clause with the addition of logic to handle the resultant payload. To further clarify this we will again give an example based on our CORBA PDL using a response message. The PCM must decide what to do with this response based on the value of the reply_status field of the message.

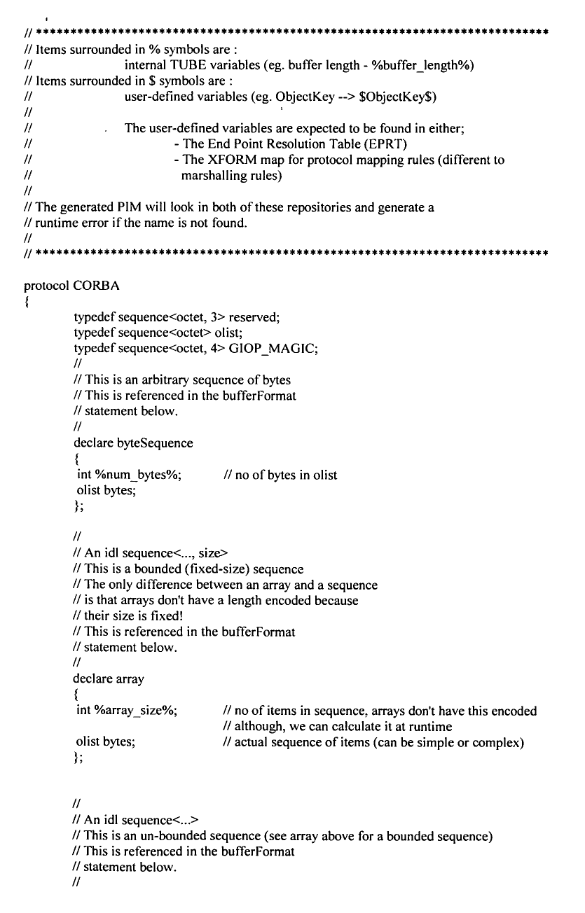

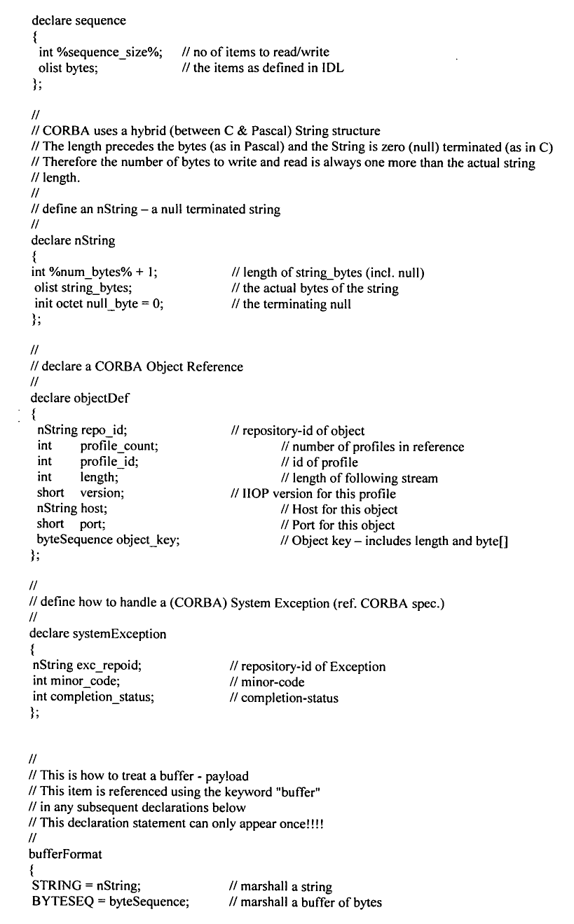

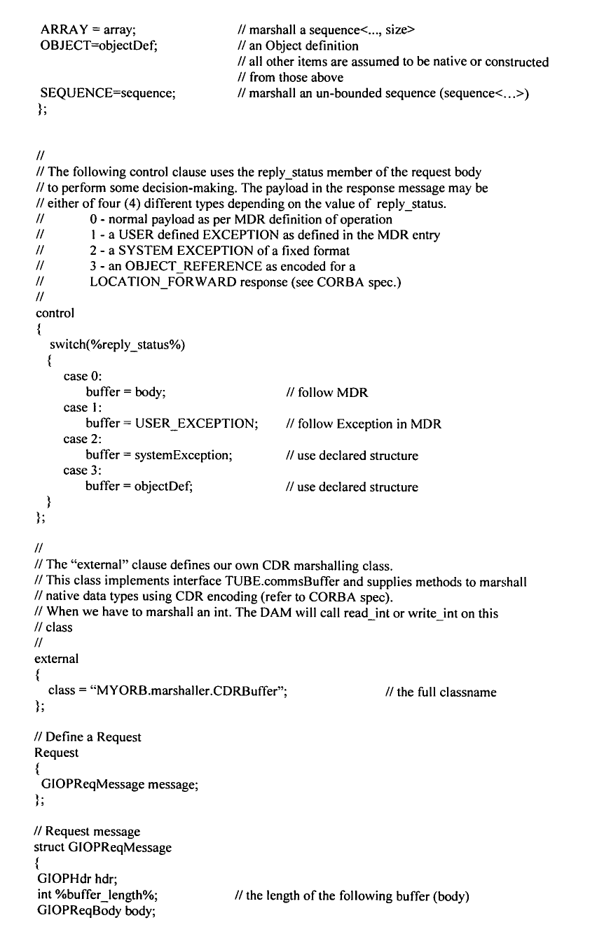

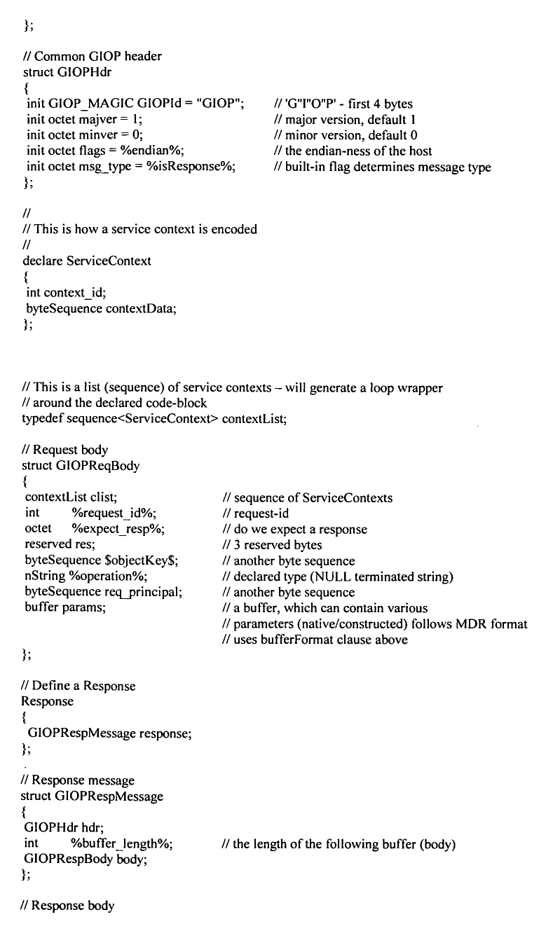

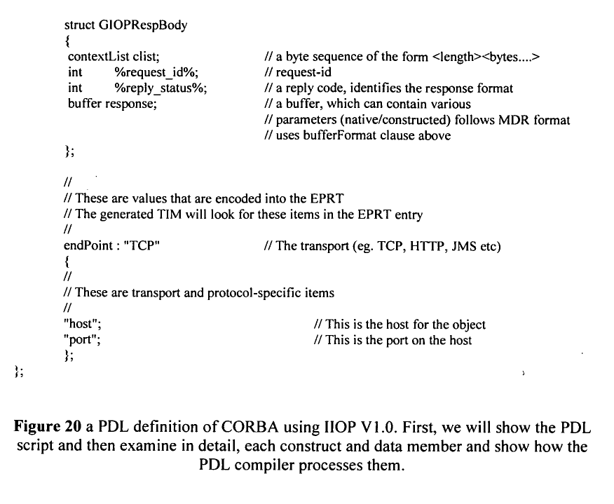

One of the values specified for reply_status in the control clause is a three (3), which signifies that the response payload is a CORBA object-reference (defined as objectDef). To a CORBA client or server the value of three (3) actually means more than the type of response payload; it means the response is a LOCATION-FORWARD response <CORBA spec.>. This indicates that we should re-marshal the original request and submit it to the object whose reference is contained in the response message. We believe an attempt to support the specification of this logic in PDL would result in an overly complex language. That is why we have chosen to delegate these higher-level semantics to a user-supplied module. The PDL still provides support for the marshalling of the various payload types, without however attempting to interpret their meaning. That is, the decision whether or not to re-submit the request to the new object is left to the PCM. The DAM API provides methods for retrieval and population of various fields within the message by name. Therefore, the PCM makes a request of DAM to re-marshall the request using the new object-reference received in the response. We must emphasise that only one PCM is required for a given protocol, and this can manage any message for any defined interface handled by this protocol. Using a CORBA LOCATION-FORWARD response message, the PCM performs the following steps (illustrated in FIG. 19):

Receive the original request from MDS

Invoke DAM to marshal the request

Invoke TMS to send the request and wait for a reply

Receive the response from TMS

Invoke DAM to un-marshal the response

Make a decision of what to do based-on the reply_status in the response

If the PCM decides to re-submit the request

Use DAM APIs to set appropriate fields in the request with new values

Return to step 2.

Return the response to MDS for subsequent return to client

The main difference between the MDS direct invocation of DAM and the PCM invocation is that MDS does not attempt to interpret any of the messages. The MDS simply routes the messages to the other components.

Once we invoke DAM either, directly from MDS or via a PCM it must dynamically adapt to the source protocol of the in-bound message, and to the target protocol of the out-bound message. The MDS or PCM will tell DAM what protocol the in-coming message is encoded in. The DAM will then search the Protocol Definition Repository (PDR) for a request PIM that implements the un-marshalling rules for the particular protocol. The DAM will throw an exception if it does not find the required PIM.

Once the source PIM is located, it is loaded and DAM checks the header for external class declarations. If we find any, DAM creates an instance of the classes using the Java Reflection API. We recall from our discussion in that these classes must implement TUBE-defined interfaces. This allows DAM to handle different buffer types and encoding schemes uniformly. Users are free to wrap or implement any underlying methods or formats that they choose. The DAM calls pre-defined method signatures to read and write the different native data types. Therefore, if a user requires compression or encryption and does not want to reveal the algorithm in the PDL definition, they can implement the algorithm in their commsBuffer class. This way the details remain hidden, whilst still taking advantage of DAM and a PIM to perform the actual traversal of the interface and its data structures. This applies to any interface, regardless of complexity. Provided we define the interface in the MDR, DAM and the PIM ensure encoding of the message as per the rules specified in the PDL definition for the protocol. The fact that we encrypt the values with a proprietary algorithm does not interfere with the encoding and de-coding process. We feel that this is a very powerful feature of the TUBE approach to message processing; special protocol handling code only needs to be written once, not for every interface. This allows optimal re-use of code and uniform treatment of all interfaces over the protocol.

The DAM uses the source PIM to un-marshal the in-bound message into an internal protocol-neutral format known as TLV (Type, Length and Value). The next step in the process is to determine the target protocol. We achieve this by using MDS APIs to look-up the Distribution Priority Table (DPT) and determine, which protocol has the highest priority. The DAM creates a request marshalling PIM for the target protocol. The DAM then uses values from the TLV to populate values within the target PIM.

TUBE's major objective to provide brokerage between different types of middleware is implemented by storing interaction rules in PIMs and TIMs. The major categories of information required by TUBE to mediate between disparate middleware are:

On-the-wire protocol and payload format.

Communications sessions. The communication sessions are further decomposed into a number of operations. These are: session-establishment (hand-shaking), session-management and session-termination. Each in-turn may require further de-composition, depending on the middleware in question. For example, session-management may involve simply sending data, or sending data and waiting for a response. The exact nature of the interaction depends on several factors: the target middleware, the session type (one-way or two-way) and the invoking application (interface) requirements.

As discussed, the Module Definition Repository holds the definition of the interface. This is necessary because there is likely to be an impedance mismatch between the two middleware interfaces, such as for example, with CORBA, which is object-based, as opposed to MQ that is message-based. The interface definition may need to be altered to reflect this. If MathServer is MQ-based, whereas its clients are CORBA-based, method calls in CORBA must be properly mapped to MQ messages to ensure that the correct operation is performed by the receiving end.

The MathServer IDL defines four methods: add, sub, mul and div. To specify the operation to MQ, we encode the parameters using information from the MDR. If the information were sent as is (i.e. with only math_req encoded), the MQ server would not know which operation to perform. Therefore, the IDL needs to be modified to reflect what MQ requires as established by the MQ server team. For example, let us assume that the MQ team established the following COBOL definition for the MathServer interface.

01 MATH_REQ.

| | |
|---|---|
| 03 OP_CODE | PIC X VALUE SPACES. |

| | | |
|---|---|---|
| 88 | ADD_OP | VALUE ‘A’. |
| 88 | SUB_OP | VALUE ‘S’. |
| 88 | MUL_OP | VALUE ‘M’. |
| 88 | DIV_OP | VALUE ‘D’. |

| | |
|---|---|
| 03 NUM1 | PIC 9(4) VALUE 0. |
| 03 NUM2 | PIC 9(4) VALUE 0. |

01 MATH_RESP.

| | |
|---|---|
| 03 RESP_NUM | PIC 9(4) VALUE 0. |

We assume for the remainder of the discussion that the server has been changed from CORBA to MQ-based and that the clients remain CORBA-based.

The data structures math_req and math_resp are almost the same, except for the op_code in the request structure. The client development team creates the IDL shown below.

```
interface MathServer
{
    struct math_req
{
    char op_code;
        int num1;
        int num2;
};
struct math_resp
{
    int resp_num;
};
// methods for each operation
struct resp_num add(in struct math_req);
struct resp_num sub(in struct math_req);
struct resp_num mul(in struct math_req);
struct resp_num div(in struct math_req);
};
```

It is worth noting that:

The interface remains largely un-altered

The request and response parameters have not changed

None of the object-oriented properties of the client interface has been violated

Simply the op_code member has been added to the request structure.

We may now use this interface with object-based and non-object based systems.

If the IDL were left in its original state, the CORBA call obj→add(10, 9) would be encoded by TUBE into an MQ message as method-name serialised-parameters, for example:
add 10 9// spaces between values are for readability only

This is the default behaviour based on the IDL definition. The onus is on the systems integrator (the client development team in this case) to ensure that the definitions match. Conversely, if the call was being marshalled from an MQ message to a CORBA call and the IDL were in its original state, TUBE would not be able to determine which method to call. This is because TUBE only receives a sequence of bytes representing the math_req structure, and therefore there is no way that the operation can be determined from the original math_req structure. The necessary information is just not there. Using the new IDL, a mapping is defined that instructs TUBE to use the op_code member of the request structure to determine the method to call on the CORBA object. There is still, however, a missing a link between the op_code value and the actual method-name. Therefore, a mapping definition such as the following is defined:

<FieldMap action=“operation”>
<Field name=“math_req.op_code” offset=“0” type=“byte”
len=”1”>
<XForm Map=“A,add M,mul D,div S,sub” />
</Field>
</FieldMap>

The XML (fragment above shows that to derive a method-name, we use either:

A byte from offset zero (0) in the in-bound buffer, and then map it according to the rules defined by the XML tag XForm. This is used when only a buffer of bytes is available, such in an MQ or JMS BytesMessage.

The op_code member of the math_req structure. This is used where the structure of the buffer (a SOAP message for example) is known, and then map it according to the rules defined by the XML tag XForm. This shows, for example, that an ‘A’ is mapped to “add”.

The following example shows a complete translation from an in-bound MQ client request to a CORBA-based object request to illustrate the mapping process. We use the add operation with the decimal numbers 1000 and 15 respectively.

MQ Message Buffer (Hexadecimal, little-endian) as extracted by MQ PIM

00000—41 - - - ASCII character ‘A’

00001—e8 03 00 00 - - - Decimal number 1000

00005—0f 00 00 00 - - - Decimal number 15

Using the rules defined in the XML shown above we derive the method name add from the byte at offset zero in this buffer. We now show how the CORBA PIM marshals these values into the CORBA GIOP request buffer. (The PIM actually receives an intermediate representation of the buffer, which is not shown here for brevity.)

GIOP Header

00000—47 49 4f 50 - - - GIOP

00004—01 01 - - - IIOP version=1.1

00006—01 - - - Byte Order=Little-Endian

00007—00 - - - Message Type=Request

00008—3c 00 00 00 - - - Message Length=60 bytes (octets)

Request Header

00012—00 00 00 00 - - - NULL (zero-length) Service Context List

00016—01 00 00 00 - - - Request-id=1

00020—01 - - - Response Expected=true//two-way call

00021—00 00 00 - - - Reserved octets

Object Key

00024—13 00 00 00 - - - Length of Object Key (octet sequence)=19 octets

00028—2f 31 35 3332 2f 31 30 34 35 32 37 31 32 38 39 2f 5f 30 00/1532/1045271289/_{—}0.

Operation and Parameters

00048—04 00 00 00 - - - Length of Method Name=4

00052—61 64 64 00 - - - NULL terminated string=“add”

00056—00 00 00 00 - - - NULL (zero-length) Requesting Principal

00060—41 - - - op_code=‘A’

00061—00 00 00 - - - CDR padding for alignment of 4 byte boundary for long value.

00064—e8 03 00 00 - - - Decimal number 1000

00068—0f 00 00 00 - - - Decimal number 15

The following excerpt from the EPRT (End-Point Resolution Table) for the MathServer interface shows the specification for the remote object key at offset 28 in the example above.

<Interface Name=“MathServer” Mode=“Synch”>

<CORBA ObjectKey=“/1532/1045271289/_{—}0” Host=“192.168.1.3” Port=“1978” endian=“1”/>

</Interface>

The CORBA TIM uses the Host and Port values to establish communication with the remote ORB, and the CORBA PIM uses the ObjectKey value to ensure that the correct object is invoked at the end-point.

Once the IDL definition is complete, the IDL is submitted to the TUBE IDL compiler, which populates the Module Definition Repository with the interface information. This information is protocol-independent. That is, the same MDR definition is used to marshal CORBA, MQ or any other supported middleware protocol. The protocol marshalling rules are already contained in the relevant PIMs and the transport (communication-level) interactions are defined in TIMs.

We will now present a detailed example of the items discussed and as shown in FIG. 20. A PDL definition of CORBA using IIOP V1.0 is shown. The PDL script and each construct and data member are shown and how the PDL compiler processes them. We will use symbolic names to represent op-code and offset values. The actual numeric values are not relevant to our discussion and we feel that symbolic names are easier to understand.

The preferred embodiment of the invention is described above in the Drawings and Description of Preferred Embodiments. While these descriptions directly describe the above embodiments, it is understood that those skilled in the art may conceive modifications and/or variations to the specific embodiments shown and described herein. Any such modifications or variations that fall within the purview of this description are intended to be included therein as well. Unless specifically noted, it is the intention of the inventor that the words and phrases in the specification and claims be given the ordinary and accustomed meanings to those of ordinary skill in the applicable art(s). The foregoing description of a preferred embodiment and best mode of the invention known to the applicant at the time of filing the application has been presented and is intended for the purposes of illustration and description. It is not intended to be exhaustive or to limit the invention to the precise form disclosed, and many modifications and variations are possible in the light of the above teachings. The embodiment was chosen and described in order to best explain the principles of the invention and its practical application and to enable others skilled in the art to best utilize the invention in various embodiments and with various modifications as are suited to the particular use contemplated.

TABLE 1
State Parameter entry

| Type | Name | Description |
|---|---|---|
| Integer | Type | Type of this variable. |
| Integer | Use | Usage of this variable. Add or subtract from |
| | | another value or use value as-is. |
| Integer | value_offset | Offset to constant value of this variable in CS. |

TABLE 2
Structure of a (Code) State-Block

| Type | Name | Description |
|---|---|---|
| Integer | op_code | Specifies the action to perform. |
| Integer | target_var | Target variable indicates the variable to |
| | | use as the source or target for this operation. |
| State | state_param | A state parameter entry for this op-code. |
| param | | |
| Integer | handler_offset | Offset to “declared” type handler map. |
| Integer | handler_name | Offset of handler name in CS. |

TABLE 3
Format of Constant Segment Entry

| Type | Name | Description |
|---|---|---|
| Integer | Type | Type of constant. |
| Integer | length | Length of constant value. |
| Byte[ ] | Name | Name of constant. |
| Byte[ ] | Value | Constant value. |

TABLE 4
Format of Variable-Definition Segment Entry

| Type | Name | Description |
|---|---|---|
| Integer | Flag | Flag to indicate if this is a system or user- |
| | | defined variable. |
| Integer | Type | Type of this variable. |
| Integer | name_offset | Offset to name of this variable in CS. |
| Integer | var_id | Symbolic identifier for this variable. This is −1 |
| | | for a user-defined variable. |

TABLE 5
In-memory layout of Variable Value Table

| Type | Name | Description |
|---|---|---|
| Integer | flag | Flag to indicate if this is a system or user- |
| | | defined variable. |
| Integer | type | Type of this variable. |
| Integer | name_offset | Offset to name of this variable in CS. |
| Object | var_value | The current value of this variable. This may be |
| | | initially empty until we read the value. |

TABLE 6
Extensions to OMG IDL

| Keyword | Description |
|---|---|
| Protocol | Signifies the beginning of a PDL script. This replaces the module or interface |
| | keywords found in IDL. |
| Request | Defines the structure of a request message. |
| Response | Defines the structure of a response message. |
| % var % | Represents an internal TUBE variable. There are several of these |
| | explained in Table 7below. An example is % operation %, which |
| | represents the operation or method to invoke on an object-based |
| | interface. It may be empty; its value depends on the protocol. |
| init | Defines a variable of the specified type with an initial value. Refer |
| | to the Variable-Definition Segment discussion below <sec. ref.>. |
| | As an example, we want to define an integer variable mynum and |
| | initialise it to the value one (1); we would write |
| | “init int mynum = 1;”. |
| control | Specifies a field in the message to use as a switch (decision |
| | making) value. This allows us to handle different types of payload |
| | depending on the value of this field. For instance, we may receive |
| | an exception rather than the expected return value. The CORBA |
| | example below demonstrates this usage. |
| buffer | Signals the start of the payload (as defined in the interface) within |
| | the message. The compound (complex) types defined by “declare” |
| | statements can be marshalled and un-marshalled from this |
| | position in the message. The processing follows the MDR |
| | definition. The only exception to this is if some condition |
| | specified in a “control” clause has been met, and this specified the |
| | execution of another code-block. |
| $var$ | Specifies a user-defined variable. We retrieve the values for these |
| | variables at marshal time from the EPRT <sec. ref.>. During un- |
| | marshalling we read them from the input stream. In either case, |
| | the value is stored in the Variable-Definition Segment entry. An |
| | example of a user-defined variable is a CORBA object-key, we |
| | define it as follows: “byteSequence $objectKey$”. This means |
| | when we reach this point in the message, read a byteSequence |
| | structure and assign its value to the variable “objectKey”. |
| struct | This is not strictly an extension to the syntax, rather a usage of the |
| | keyword struct. We use this to define individual parts of the |
| | message, such as header, body or trailer. Each struct declaration |
| | causes the generation of a CODE_BLOCK (see Error! Reference |
| | source not found.). This allows different parts of the message to |
| | be handled out-of sequence. Where it may be necessary to re- |
| | marshal only some values. We explain this fully in the DAM |
| | CORBA example. |
| declare | Define marshalling rules for a particular compound (complex) |
| | type. |
| bufferFormat | Defines how to encode/decode declared types encountered in the |
| | payload (refer to Error! Reference source not found.). |
| endPoint | Defines the communications end-point in protocol-specific terms. |
| external | Defines an external class that will provide marshalling functions |
| | for this protocol and communication management functions. If |
| | there are no external classes defined, TUBE will use its own to |
| | carry out these operations. The specified classes must implement |
| | specific TUBE defined interfaces. These classes may be used as |
| | wrappers around vendor-specific or home-grown APIs. |
| sequence | This is not an extension. It causes the generation of a looping |
| | wrapper around the CODE_BLOCK, which marshals the defined |
| | type. This is closely associated to the % count % (internal) variable, |
| | which holds the value of the loop count. TUBE must know from |
| | this definition, at what point and from where in the message, to |
| | read this value. In the case of marshalling, TUBE will write this |
| | value into this point in the message. The encoding of the specified |
| | sequence then follows. |

TABLE 7
TUBE internal variables

| Variable | Description | Marshalling | Un-marshalling |
|---|---|---|---|
| endian | Defines the endian | Value obtained | Value stored for |
| | representation of the | from EPRT entry. | reference only. |
| | target host. | | |
| buffer_length | Specifies the overall | Encoded after | Read before payload. |
| | length of the payload. | payload. | |
| request_id | Ensures processing in | Read from entry | Stored in entry. |
| | correct sequence. | and encoded. | |
| isResponse | Determines if this is a | Read from entry | Stored in entry. |
| | response message. | and encoded. | |
| operation | Specifies the method | Read from entry | Stored in entry. |
| | to invoke. Only | and encoded or | |
| | applies to protocols | obtained from an | |
| | that support methods¹. | XFORM map. | |
| | | Marshalling | Un-marshalling |
| expect_resp | Specifies if this is a | Read from entry | Stored in entry. |
| | two-way invocation. | and encoded. | |
| num_bytes | The number of bytes | Read from entry | Stored in entry and |
| | in the next set of | and used to write | used to read next |
| | bytes. | next block of | block of bytes. |
| | | bytes. | |
| reply_status | The status of the | Read from entry | Stored in entry. |
| | communication | and encoded. The | |
| | session. Only applies | value is protocol- | |
| | to responses. | specific. | |
| target_tlv | Read/Write the value | Read from TLV | Stored in TLV |
| | from a TLV entry. We | entry and | entry. |
| | use the TLV primarily | encoded. | |
| | for payload | | |
| | processing. | | |
| count | Internally created | Written at the | Read from stream |
| | when we encounter | start of a loop | at expected start of |
| | “sequence” in PDL. | wrapper. | a loop. |
| array_size | Internally created | Value obtained | Value obtained |
| | when an item is | from MDR entry. | from MDR entry. |
| | defined as an ARRAY | | |
| sequence_size | The size (in elements) | Read from entry | Written from entry. |
| | of the sequence to | and encoded. | |
| | read/write | | |

TABLE 8
op-codes generated for reading a byteSequence

| | Source/Target | |
|---|---|---|
| OP-Code | variable | Comment |
| READ_INT | | Read an integer from input |
| PUSH | Put on top of | |
| | value stack | |
| POP | Get value on top | |
| | of value stack | |
| ASSIGN_TO | NUM_BYTES | Assign value to internal |
| | | NUM_BYTES |
| GET_FROM | NUM_BYTES | Retrieve NUM_BYTES |
| READ_OCTETARRAY | | Read NUM_BYTES octets |
| PUSH | | Put octet array on top of |
| | | value stack. Caller will |
| | | POP and retrieve |
| | | value. |
| END_BLOCK | | End of this code-block |

TABLE 9
op-codes for reading a null terminated string

| OP-Code | Source/Target variable | Comment |
|---|---|---|
| READ_INT | | Read an integer from input |
| SUB | Subtract a value from the | We have an offset to the |
| | offset into the CS from the | value “1” in the CS. |
| | value just read | |
| PUSH | Put on top of value stack | We now have value −1 |
| USER_DEFINED | | A declared code block |
| POP | Get value on top of value | |
| | stack | |
| ASSIGN_TO | NUM_BYTES | Assign value to |
| | | NUM_BYTES |
| GET_FROM | NUM_BYTES | Retrieve NUM_BYTES |
| READ_OCTETARRAY | | Read NUM_BYTES octets |
| PUSH | | Put octet array on top of |
| | | value stack. Caller will POP |
| | | and retrieve value. |
| READ_OCTET | | Read null byte |
| END_BLOCK | | End of this code-block |

TABLE 10
op-codes for reading an object reference

| | Source/Target | |
|---|---|---|
| OP-Code | variable | Comment |
| USER_DEFINED | | A declared code-block |
| LOAD_BLOCK | repo_id | Load and execute the block |
| | | named “nString_READ” and |
| | | place the value in the variable |
| | | “repo_id” |
| READ_INT | profile_count | Read an integer and assign it |
| | | to the variable “profile_count” |
| READ_INT | profile_id | Read an integer and assign it |
| | | to the variable “profile_id” |
| READ_INT | length | Read an integer and assign it |
| | | to the variable “length” |
| READ_SHORT | version | Read a short and assign it to |
| | | the variable “version” |
| LOAD_BLOCK | host | Load and execute the block |
| | | named “nString_READ” and |
| | | place the value in the variable |
| | | “host” |
| READ_SHORT | port | Read a short and assign it to |
| | | the variable “port” |
| LOAD_BLOCK | object_key | Load and execute the block |
| | | named |
| | | “byteSequence_READ” and |
| | | place the value in the variable |
| | | “object_key” |
| END_BLOCK | | End of this code-block |

TABLE 11
Op-codes for processing “control” clause

| OP-Code | Source/Target variable | Comment |
|---|---|---|
| TEST_EQ | REPLY_STATUS | Test if reply_status == 0 |
| JUMP | LABEL_0 | The test returns true. Jump to |
| | | the given label. |
| TEST_EQ | REPLY_STATUS | Test if reply_status == 1 |
| JUMP | LABEL_1 | The test returns true. Jump to |
| | | the given label. |
| TEST_EQ | REPLY_STATUS | Test if reply_status == 2 |
| JUMP | LABEL_2 | The test returns true. Jump to |
| | | the given label. |
| TEST_EQ | REPLY_STATUS | Test if reply_status == 3 |
| JUMP | LABEL_3 | The test returns true. Jump to |
| | | the given label. |
| PUSH | Exception | All tests failed. Push an |
| | | Exception value onto the |
| | | stack. This causes the |
| | | interpreter to throw an |
| | | exception. |
| JUMP | LABEL_4 | Jump to the last label. |
| LABEL_0 | | |
| PUSH | False | Push a false value onto the |
| | | stack. This is the return value. |
| | | Therefore, we follow the |
| | | MDR. |
| JUMP | LABEL_4 | Jump to the last label. |
| LABEL_1 | | This is an MDR-defined |
| | | Exception. |
| PUSH | True | Return true |
| LABEL_2 | “systemException_READ” | Push the name of the block to |
| PUSH | | decode a system exception. |
| JUMP | LABEL_4 | Jump to the last label. |
| JUMP | LABEL_4 | Jump to the last label. |
| LABEL_3 | | |
| PUSH | “objectDef_READ” | Push the name of the block to |
| | | decode an object definition. |
| JUMP | LABEL_4 | Jump to the last label. |
| LABEL_4 | | Return value on top of stack. |

TABLE 12
Post-Marshal map for CORBA message

| OP-Code | Source/Target variable | Comment |
|---|---|---|
| SAVEPOS | BUFFER_POS | Save current buffer position. |
| SETPOS | BUFFER_POS | Set the buffer position to the |
| | (POS = 8) | value of the constant at the |
| | | offset given by the parameter. |
| SUBTRACT | A constant value of | Subtract the length of the |
| | “12” from the buffer | header + the length of the |
| | length. Header length | integer from the buffer_length |
| | (8) + length of integer | to give only payload length. |
| | (4) = 12. | |
| WRITE_INT | BUFFER_LENGTH | Write-out the value of the |
| | | internal variable buffer_length |
| GETPOS | BUFFER_POS | Get the saved buffer position. |
| SETPOS | BUFFER_POS | Set the buffer position to the |
| | | saved value. |

TABLE 13
PDL Op-codes

| | | |
|---|---|---|
| OP-Code | Description | Comments |

| | |
|---|---|
| READ_OCTET | Read a single octet (byte) |
| | from a source. |
| WRITE_OCTET | Write a single octet (byte) |
| | to a target |
| JUMP | Jump to the given LABEL |
| LABEL | The target of a JUMP |
| | instruction. |
| LOOP | The start of a looping |
| | sequence. |
| LOOP_END | The end of a looping |
| | sequence. |
| Etc. | |

1. A method of flow of an outbound communication to another module with interface including the steps of:
i. assessing the application of the outbound communication to determine and select a protocol to try from a table of protocols in a priority arrangement;
ii. using the selected protocol to determine the format and arguments for the outbound communication;
iii. using the protocol definitions stored to prepare the outbound communication for the particular middleware or application service;
iv. providing required buffer;
v. determining which protocol to use for transmission;
vi. looking up table of end-point resolutions to determine the communication parameters required to communicate with the selected transmission protocol;
vii. attempting to communicate with the designated host using the appropriate communication parameters; and
viii. if communication with the selected protocol fails selecting the next protocol to try from the table of protocols in the priority arrangement.

2. A method of flow of an outbound communication to another module with interface according to claim 2 using a broker which is able to review all data structures, regardless of complexity, as being comprised of a finite set of primitive data types (e.g. integer, float etc.) and with reference to the repository determine a mechanism for reading and writing these types to enable processing of structures of arbitrary complexity, wherein the rules and mechanisms for reading these basic types are defined by the protocol and once the rules are captured allow processing of any message over this protocol

3. A method of flow of an inbound communication from another module with interface including the steps of:
i. receiving inbound message in the protocol that it was sent;
ii. looking up table to determine whether the message needs marshalling into another protocol before passing the inbound communication to the target application on the local system;
iii. if message needs marshalling into another protocol, determining the preferred protocol from a table according to priority;
iv. determining the format and arguments for the inbound communication;
v. using stored protocol definitions for the selected protocol to prepare the inbound communication for the target middleware or application service;
vi. buffering the inbound communication as required;
vii. determining protocol to use for transmission.
viii. determining local end point of the target application on the local system; and
ix. at run time passing the inbound communication to the target application on the local system.

4. A method of flow of an inbound communication from another module with interface according to claim 3 using a broker which is able to review all data structures, regardless of complexity, as being comprised of a finite set of primitive data types (e.g. integer, float etc.) and with reference to the repository determine a mechanism for reading and writing these types to enable processing of structures of arbitrary complexity, wherein the rules and mechanisms for reading these basic types are defined by the protocol and once the rules are captured allow processing of any message over this protocol

5. A method of flow of an inbound communication from another module with interface according to claim 4 in which rules and middleware characteristics are specified in a repository, for the system broker to provide the connection and transformation for the middleware protocols, as well as for legacy systems and wherein it is not necessary to have a converter at either end of the communication and further it is not necessary for there to be two way communication in order to ensure the receiver knows what format is arriving, instead the conversion due to the relevant structure format correlations allows ready flow of data from one input protocol to form readable by output protocol.

6. A method of intercommunication across communication protocols including the steps of:
a. defining the structure of one or more protocols used in communication using a Protocol Definition Language, compiling this structure into a byte-code structure and storing said result structure in a library;
b. at run time analysing an input communication and determining an appropriate input structure of protocol of the input communication from the library and analysing the path of the intended output communication and determining an appropriate output structure of protocol of the output communication from the library;
c. providing a dynamic marshaller for processing of the byte-code structure at run time and sending the information in accordance with the identified output structure from the corresponding relevant sections of the identified input structure;
d. wherein the method allows ready communication between various communication protocols and middleware systems.

7. A method of intercommunication according to claim 6 including
a. providing ability to define new encoders and decoders using said Protocol Definition Language or to specify external pre-existing encoders and decoders using said Protocol Definition Language; and
b. providing ability to define new transport mechanisms or specify external pre-existing transport mechanisms using said Protocol Definition Language.

8. A method of intercommunication according to claim 7 including the library having a predefined conversion of the structure of one or more protocols to the structure of another of the one or more protocols.

9. A method of intercommunication according to claim 8 wherein the dynamic marshaller provides buffering and/or addressing as required.

10. A method of intercommunication according to any one of claims 9 also providing for the dynamic marshaller to include definable predefined processing steps of corresponding relative sections of the identified output structure to the identified input structure.

11. A method of intercommunication according to claim 10 wherein the dynamic marshaller is able to review all data structures, regardless of complexity, as being comprised of a finite set of primitive data types (e.g. integer, float etc.) and with reference to the repository determine a mechanism for reading and writing these types to enable processing of structures of arbitrary complexity, wherein the rules and mechanisms for reading these basic types are defined by the protocol and once the rules are captured allow processing of any message over this protocol.

12. A method of intercommunication according to any one of claims 11 wherein the predefined processing steps are protocol neutral such that an end user output defines the processing steps in a generic manner and the dynamic marshaller undertakes the required manipulation of the data in any communication based on the predefined processing step of the relevant section of the communication protocol structure so as to provide a required effect regardless of the protocols of communication.

13. A method of intercommunication according to any one of claims 12 wherein a language neutral machine independent definition is compiled into binary modules known as protocol implementation modules (PIMs) and transport interface modules (TIMs) which contain the communication parameters, and wherein the PIMs and TIMs are loaded at runtime and executed by interpreters (virtual machines) with the PIMs processed by the dynamic marshaller and the TIMs handled by a transport mediation server and both of these modules are controlled by a message distribution server (MDS) which is also responsible for any interface mapping that is required and uses either the processed request or response message and a mapping definition with the actual mapping being performed by a mapper module under the direction and control of the MDS.
